(19) United States
(12) Patent Application Publication
(10) Pub. No.: US 2006/0233973 A1
(43) Pub. Date: Oct. 19, 2006

(54) Cellulose ester film, manufacturing method thereof, optical film, polarizing plate and liquid crystal display

(75) Inventors: Kazuaki Nakamura, Tokyo (JP); Kazuto Kiyohara, Tokyo (JP); Satomi Kawabe, Tokyo (JP); Akihiko Takeda, Tsukui-gun (JP); Yasushi Okubo, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KONICA MINOLTA OPTO, INC.

(21) Appl. No.: 11/401,388

(22) Filed: Apr. 11, 2006

(30) Foreign Application Priority Data
Apr. 18, 2005 (JP) JP2005-119515

(51) Int. Cl. C09K 19/00

(52) U.S. Cl. 428/1.31

(57) ABSTRACT

A method of producing a cellulose ester film comprising the steps of: (i) melting a cellulose ester containing 5.0% by weight or less of water at a temperature in the range of 150 to 300° C.; and (ii) melt casting the molten cellulose ester to form the cellulose ester film, wherein a compound having both a phenol moiety and a hindered amine moiety in the molecule is incorporated in the cellulose ester.

This application is based on Japanese Patent Application No. 2005-119515 filed on Apr. 18, 2005 in Japanese Patent Office, the entire content of which is hereby incorporated by reference.

### FIELD OF THE INVENTION

The present invention relates to a cellulose ester film formed by a melt casting method, a manufacturing method thereof, an optical film, a polarizing plate utilizing the optical film as a polarizing plate protective film, and a liquid crystal display utilizing the polarizing plate.

### BACKGROUND OF THE INVENTION

A liquid crystal display device (LCD) has been widely employed as a display device for such as a word processor, a personal computer, a TV, a monitor and a portable information terminal, since it is capable of being directly connected to an IC circuit with a low voltage and small electric power consumption, and particularly capable of being made thinner. The LCD is primarily constituted of, for example, a liquid crystal cell the both sides of which provided with a polarizing plate.

A polarizing plate passes only a polarized wave plane of a definite direction. Therefore, an LCD bears an important role to visualize the variation of orientation of a liquid crystal caused by the variation of electric field. That is, capabilities of an LCD are largely controlled by capabilities of a polarizing plate.

A polarizer of a polarizing plate is a polymer film which is adsorbed with such as iodine and then stretched. That is, after a solution called as H ink containing dichromic substance (iodine) has been wet adsorbed on polyvinyl alcohol film, the film is mono-axially stretched to make the dichromic substance oriented in one direction. As a protective film for a polarizing plate, cellulose resin or specifically cellulose acetate has been utilized.

A cellulose film has been commonly utilized since it is optically and physically useful as a protective film for a polarizing plate. However, because the manufacturing method of the film has been a flow casting method employing a halogen-containing solvent, the cost to recover the solvent has been a rather heavy load. Therefore, solvents other than a halogen-containing solvent have been tested in various ways, however, no substitute to provide satisfactory solubility was found. In addition to seeking for a substitute solvent, new dissolution methods such as a cooling method have been tested (for example, refer to Patent Document 1), however, it is not fully easy to be practically employed in an industrial application and further investigation has been required.

Further, disclosed is a technology to improve optical characteristics and mechanical characteristics by addition of a hindered phenol antioxidant, a hindered amine photo-stabilizer or an acid scavenger into cellulose ester at a certain addition rate (for example, refer to Patent Document 2). Also disclosed are a technology utilizing a polyalcohol ester plasticizer (for example, refer to Patent Document 3) and a technology utilizing a polyalcohol ester plasticizer having a specified structure (for example, refer to Patent Document 4).

Anyway, cellulose ester film for an optical application has burdens of manufacturing and facility accompanied by utilization of solvents in the manufacturing process and is still in an unsatisfactory state with respect to optical and mechanical characteristics.

In recent years, attempts to melt cast cellulose ester, for application in silver halide photography or polarizer protective film, has been made, however, since cellulose ester is a polymer having a very high viscosity at molten state and has a high glass transition temperature, levering of the film is not fully easy when cellulose ester is melted and extruded from dice to be cast on a cooling drum or on a cooling belt, and because it solidifies in a short time after extruded, it has been found that such a cellulose ester film has problems in loss of flatness, tendency to cause curling, loss of dimensional stability, unevenness in retardation which is an optical characteristic and specifically unevenness in retardation in the width direction of the film, when compared with a solution cast film.

The compounds utilized in the present invention have been known (for example, refer to Patent Document 7).

Patent Document 1 JP-A No. 10-95861 (hereinafter, JP-A refers to Japanese Patent Publication Open to Public Inspection)

Patent Document 2 JP-A No. 2003-192920

Patent Document 3 JP-A No. 2003-12823

Patent Document 4 JP-A No. 2003-96236

Patent Document 5 Japanese Translation of PCT International Application Publication No. 6-501040

Patent Document 6 JP-A No. 2000-352620

Patent Document 7 Examined Japanese Patent Application Publication No. 60-29387

### SUMMARY OF THE INVENTION

An object of the present invention is to provide a cellulose ester film which can reduce a manufacturing burden and a facility burden caused by drying and recovering a solvent used in the production process, a production method of the cellulose ester film and an optical film, specifically, to provide a polarizing plate utilizing the optical film exhibiting a retardation property uniform in the width direction and a liquid crystal display utilizing the polarizing plate.

One of the aspects of the present invention is a method of producing a cellulose ester film comprising the steps of: (i) melting a cellulose ester containing 5.0% by weight or less of water at a temperature in the range of 150 to 300° C.; and (ii) melt casting the molten cellulose ester to form the cellulose ester film, wherein a compound having both a phenol moiety and a hindered amine moiety in the molecule is incorporated in the cellulose ester.

### DESCRIPTION OF THE PREFERRED EMBODIMENTS

The above object of the present invention is achieved by the following structures.

(1) A method of producing a cellulose ester film comprising the steps of:

(i) melting a cellulose ester containing 5.0% by weight or less of water at a temperature in the range of 150 to 300° C.; and

(ii) melt casting the molten cellulose ester to form the cellulose ester film,

wherein a compound having both a phenol moiety and a hindered amine moiety in the molecule is incorporated in the cellulose ester.

(2) The method of Item (1), wherein the compound having both a phenol moiety and a hindered amine moiety in the molecule comprises at least two hindered amine moieties in the molecule.

(3) The method of Item (1) or Item (2), wherein the compound having both a phenol moiety and a hindered amine moiety in the molecule is a compound having the phenol moiety at an end of the molecule and the hindered amine moiety at another end of the molecule.
(4) The method of any one of Items (1) to (3), wherein the compound having both a phenol moiety and a hindered amine moiety in the molecule is a hydroxybenzylmalonic ester derivative represented by Formula (I) or an acid addition salt thereof: 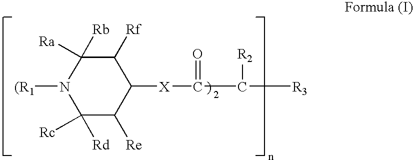
wherein, in Formula (I):

(a) n represents 1 or 2;

(b) Ra, Rb and Rd each represent an alkyl group having 1 to 6 carbon atoms;

(c) Rc represents an alkyl group having 1 to 9 carbon atoms;

(d) Re and Rf each represent a hydrogen atom or an alkyl group having 1 to 5 carbon atoms, provided that Re and Rf are exchangeable with each other;

(e) X represents a —O— group or a —NR— group (R represents a hydrogen atom or an alkyl group);

(f) R₁ represents a hydrogen atom, an —O. group, an alkyl group having 1 to 12 carbon atoms, an alkenyl group having 3 or 4 carbon atoms or an A-CO— group where A represents an alkyl group having 1 to 12 carbon atoms;

(g) R₂ represents a hydroxybenzyl group represented by Formula (II); and

(h) when n=1, R₃ represents one of the following groups:
(i) an alkyl group having 1 to 10 carbon atoms, the alkyl group being substituted with at least one of the following groups: an alkyl group having 1 to 20 carbon atoms, a —COOR₁₂ group (wherein R₁₂ represents an alkyl group having 1 to 18 carbon atoms or a group represented by Formula (III)), a —OCOR₁₃ group (wherein R₁₃ represents a phenyl group which may be substituted with an alkyl group having 1 to 4 carbon atoms or a hydroxyl group, or may have no substituent), and a —P (°) (OR₁₄)₂ group (wherein R₁₄ represents an alkyl group having 1 to 8 carbon atoms),
(ii) an alkenyl group having 3 to 18 carbon atoms,
(iii) an aralkyl group of 7 having 19 carbon atoms,
(iv) a phenyl group,
(v) a —OCOR₁₅ group (wherein R₁₅ represent a phenyl group substituted with two alkyl groups each having 1 to 4 carbon atoms and a hydroxyl group, or an alkyl group having 1 to 12 carbon atoms), and
(vi) a —NHCOR₁₆ group (wherein R₁₆ represents an alkyl group having 1 to 12 carbon atoms), and
when n=2, R₃ represents an alkylene group having 1 to 20 carbon atoms: 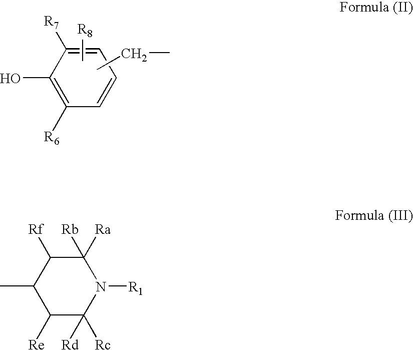
   wherein, in Formula (II), R₆ and R₇ each independently represent an alkyl group having 1 to 9 carbon atoms and R₈ represents a hydrogen atom or a methyl group), and in Formula (III), R₁, Ra, Rb, Rc, Rd, Re and Rf are common to R₁, Ra, Rb, Rc, Rd, Re and Rf, respectively, in Formula (I).
   (5) The method of Item (4), wherein, in Formula (I), Ra, Rb, Rc and Rd each represent a methyl group, and Re and Rf each represent a hydrogen atom.
   (6) The method of Item (4) or Item (5), wherein, in Formula (I):

(a) X represents a —O— group or a —NH— group;

(b) R₁ represents a hydrogen atom, an —O. group, an alkyl group having 1 to 4 carbon atoms, an allyl group, or an acetyl group;

(c) R₂ represents a hydroxybenzyl group represented by Formula (IIa) or Formula (IIb);

(d) when n=1, R₃ represents one of the following groups:
(i) an alkyl group having 1 to 4 carbon atoms, the alkyl group being substituted with 1 or 2 groups of: a non-substituted alkyl group having 1 to 18 carbon atoms, a —COOR₁₂ group (wherein R₁₂ represents an alkyl group having 1 to 4 carbon atoms or a group represented by Formula (III)), an —OCOR₁₃ group (wherein R₁₃ represents a phenyl group), and a —P(O) (OR₁₄)₂ group (wherein R₁₄ represents an alkyl group having 1 to 4 carbon atoms),
(ii) an alkenyl group having 3 to 6 carbon atoms,
(iii) a phenyl group,
(iv) an aralkyl group of 7 having 15 carbon atoms,
(v) a —OCOR₁₅ group (wherein R₁₅ represent an alkyl group having 1 to 12 carbon atoms, a phenyl group, a 3,5-di-tertiarybutyl-4-hydroxyphenyl group or a 2-(3,5-di-tertiarybutyl)-4-hydroxyphenyl-ethyl group), and
(vi) a —NHCOR₁₆ group (wherein R₁₆ represents an alkyl group having 1 to 12 carbon atoms), and
when n=2, R₃ represents an alkylene group having 1 to 12 carbon atoms: 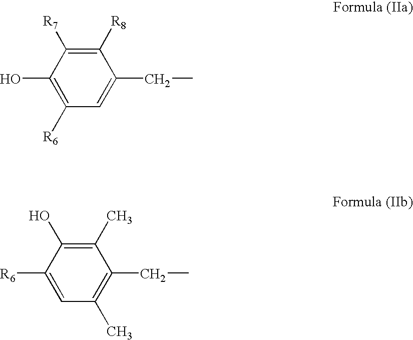
   wherein, in Formulae (IIa) and (IIb), R₆ and R₇ each independently represent an alkyl group having 1 to 4 carbon atoms and R₈ represents an hydrogen atom or a methyl group.
   (7) The method of any one of Items (4) to (6), wherein, in Formula (I):

(a) n represents 1 or 2;

(b) Ra, Rb, Rc and Rd each represent a methyl group;

(c) Re and Rf each represent a hydrogen atom;

(d) X represents an —O— group;

(e) R₁ represents a hydrogen atom, an —O. group, an alkyl group having 1 to 4 carbon atoms, an allyl group, or an acetyl group;

(f) R₂ represents a hydroxybenzyl group represented by Formula (IIa) or Formula (IIb); and

(g) R₃ represents one of the following groups:
(i) an alkyl group having 1 to 18 carbon atoms, the alkyl group being substituted with one or two groups of: a non-substituted alkyl group having 1 to 18 carbon atoms, and a —COOR₁₂ group (wherein R₁₂ represents an alkyl group having 1 to 4 carbon atoms or a group represented by Formula (IIIa)); or a —P(O) (OR₁₄)₂ group (wherein R₁₄ represents an alkyl group having 1 to 4 carbon atoms),
(ii) an ally group,
(iii) a benzyl group,
(iv) a phenyl group,
(v) an alkylene group having 1 to 8 carbon atoms, and
(vi) a xylylene group: 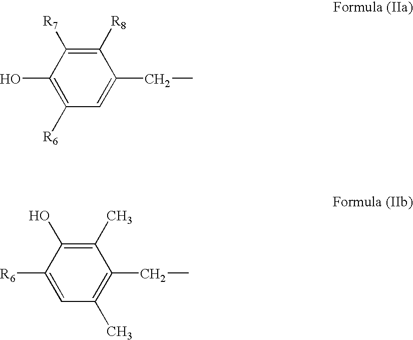
   wherein, in Formulas (IIa) and (IIb), R₆ represents a tertiary butyl group, R₇ represents a methyl group or a tertiary butyl group and R₈ represents a hydrogen atom or a methyl group, 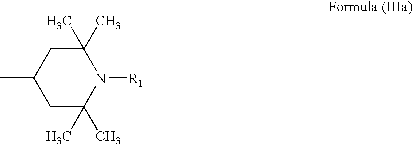
   wherein, in Formula (IIIa), R₁ is common to R₁ in Formula (I).
   (8) The method of Item (4), wherein, in Formula (I):

(a) n represents 1 or 2;

(b) Ra, Rb and Rd each represent an alkyl group having 1 to 6 carbon atoms;

(c) Rc represents an alkyl group having 1 to 9 carbon atoms;

(d) Re and Rf each represent a hydrogen atom or an alkyl group having 1 to 5 carbon atoms, provided that Re and Rf are exchangeable with each other;

(f) R₁ represents a hydrogen atom, an —O. group, an alkyl group having 1 to 12 carbon atoms, an alkenyl group having 3 or 4 carbon atoms or an A-CO— group where A represents an alkyl group having 1 to 12 carbon atoms;

(g) R₂ represents a hydroxybenzyl group represented by Formula (II); and

(h) when n=1, R₃ represents one of the following groups:
(i) an alkyl group having 1 to 10 carbon atoms, the alkyl group being substituted with one of the following groups: a non-substituted alkyl group having 1 to 20 carbon atoms, a —COOR₁₂ group (wherein R₁₂ represents an alkyl group having 1 to 18 carbon atoms or a group represented by Formula (III)), a —OCOR₁₃ group (wherein R₁₃ represents a phenyl group which may be substituted with an alkyl group having 1 to 4 carbon atoms or a hydroxyl group, or may have no substituent), and a —P(O) (OR₁₄)₂ group (wherein R₁₄ represents an alkyl group having 1 to 8 carbon atoms),
(ii) an alkenyl group having 3 to 18 carbon atoms,
(iii) an aralkyl group of 7 having 19 carbon atoms, and
(iv) a phenyl group;
when n=2, R₃ represents an alkylene group having 1 to 20 carbon atoms.
   (9) The method of any one of Items (1) to (8), wherein the cellulose ester comprised in the cellulose ester film is selected from the group consisting of: cellulose acetate, cellulose propionate, cellulose butyrate, cellulose acetate propionate, cellulose acetate butyrate, cellulose acetate phthalate and cellulose phthalate.
   (10) The method of any one of Items (1) to (9), wherein the cellulose ester film comprises at least one of the following plasticizers: an ester plasticizer comprising a polyalcohol and a monocarboxylic acid; and an ester plasticizer comprising a polycarboxylic acid and a monoalcohol.
   (11) The method of Item (10), wherein the cellulose ester film comprises an alkylpolyalcohol aryl ester plasticizer or a dialkylcarboxylic acid alkyl ester plasticizer.
   (12) The method of Item (10) or Item (11), wherein a weight content of the ester plasticizer comprising a polyalcohol and a monocarboxylic acid or the ester plasticizer comprising a polycarboxylic acid and a monoalcohol, is in the range of 1 to 30% by weight based on the weight of the cellulose ester.
   (13) The method of any one of Items (1) to (12), wherein a weight content of the compound having both a phenol moiety and a hindered amine moiety in the molecule is in the range of 0.01 to 5% by weight based on the weight of the cellulose ester.
   (14) The method of any one of Items (1) to (13), wherein the cellulose ester contains 3.0% by weight or less of water.
   (15) A cellulose ester film produced by the method of any one of Items (1) to (14).
   (16) An optical film employing the cellulose ester film of Item (15).
   (17) A polarizing plate produced by adhering the optical film of Item (16) on a surface of a polarizer film.
   (18) A liquid crystal display employing the optical film of Item (16) or a polarizing plate produced by adhering the optical film of Item (16) on a surface of a polarizer film.

The present invention is characterized in that cellulose ester film manufactured by a melt casting method contains at least one compound provided with both of a phenol moiety and a hindered amine moiety in one molecule.

Further, a compound provided with both of a phenol moiety and a hindered amine moiety in one molecule is preferably a compound provided with at least one phenol moiety and at least two hindered amine moieties in one molecule. On the other hand, a compound such as Sanol LS-2626, in which a hindered amine moiety is not located at the end of the molecule, may be utilized, however, it is preferable to utilize a compound provided with both of a phenol moiety and a hindered amine moiety in one molecule, in which a phenol moiety is located at an end of the molecule and a hindered amine moiety is also located at another end of the molecule. In the present invention, for example, all the compounds defined by aforesaid Formula (I) are regarded as compounds in which a phenol moiety and a hindered amine moiety are located at the ends of the molecule. Further, a molecular weight of a compound provided with both of a phenol moiety and a hindered amine moiety in one molecule is preferably 400-2,000 and more preferably 500-1,500. When the molecular weight is in the above-described range, it is preferable that said molecule has high heat resistance and excellent compatibility with cellulose ester.

The solution casting method which is one of the methods to manufacture a cellulose ester film, is a method in which cellulose ester is dissolved in a solvent and the solution is cast to form a film, after which the solvent is removed by evaporation to dry the film. In this method, because the solvent remaining in the film must be removed, a drying line, drying energy and devices for recovering and recycling the evaporated solvent must be provided, leading to extremely high investment for installation and manufacturing, and reduction of these inherent costs is an important problem to be solved.

Alternatively, in film production using the melt casting method, because no solvent is used for preparing the solution of the cellulose ester for melt casting, the drying load and installation load described above are not necessary.

When an un-dried cellulose ester is formed into a film using the melt casting method, small bubbles are generated at the time of molding, resulting in deterioration of optical properties such as haze, transmittance, and retardation. By performing melt casting using a cellulose ester exhibiting water content not greater than 5.0 weight % (preferably not greater than 3.0 weight %), haze is reduced as a result of reduced water content whereby optical properties are improved. Also by using an ester plasticizer formed from a polyalcohol and a monocarboxylic acid, and/or an ester plasticizer formed from a polycarboxylic acid and a monoalcohol as the plasticizer, affinity to the cellulose ester is increased and as a result, optical and mechanical properties of the cellulose ester film are enhanced.

In the present invention, it was found that, when a cellulose ester film is produced by a melt casting method using cellulose ester incorporated with a compound containing both a phenol moiety and a hindered amine moiety in the molecule, the uniformity in retardation values in the lateral direction of the cellulose ester film is astonishingly improved. Herein, the lateral direction of the film represents a direction perpendicular to the film transport direction in the melt casting method.

Further, in the case where cellulose ester film is prepared using the solution casting method, luminescent points of foreign matter are generated, while when the cellulose ester film is prepared using the melt casting method, the amount of generated luminance points of foreign matter is reduced.

Melt casting in the present invention is defined as a method in which a cellulose ester is melted by heating the cellulose ester to a temperature where the cellulose ester becomes fluid, and, without using a solvent, the fluid cellulose ester is cast. Processing methods including a heat-melting process are further classified into, for example, a melt-extrusion method, a press method, an inflation method, an injection method, a blowing method and a stretching method. Of these, the melt-extrusion method. is excellent to obtain an optical film with superior mechanical strength and superior surface accuracy. The method of cellulose ester film production of the present invention includes the melt casting method to form a film, in which the film forming materials are heated, and after a fluid state is obtained, the fluid is extruded on a drum or an endless belt to form the film. Cellulose ester may be added with other compounds. When a compound is added into cellulose ester, the compound may be added either into thermally melted cellulose ester or into cellulose ester before being thermally melted.

In aforesaid Formula (I), Ra, Rb and Rd represent a straight chain or branched alkyl group having a carbon number of 1-6 and preferably an unsubstituted straight chain or branched alkyl group such as a methyl, ethyl, propyl, butyl, isobutyl, isopentyl or n-hexyl group. Rc represents a straight chain or branched alkyl group having a carbon number of 1-9 such as a methyl, ethyl, propyl, butyl, isobutyl, isopentyl, n-hexyl, 2-ethylhexyl, n-nonyl or isononyl group. Re and Rf represent an alkyl group having a carbon number of not more than 5, however, Re preferably has a carbon number of less by one compared to Rb, and the positions of Re and Rf can be exchangable each other.

Herein, in the present invention, in the case of simply referred as “-group”, the “-group” includes a straight chain compound and a branched compound as well as includes a substituted compound and an unsubstituted compound.

Preferable Ra, Rb, Rc and Rd are a methyl group and preferable Re and Rf are a hydrogen atom. R₁, R₁₆ and A, which represent an alkyl group having a carbon number of 1-12, are a primary alkyl group such as a methyl, ethyl, n-propyl, n-butyl, n-hexyl, n-octyl, n-decyl or n-dodecyl group.

When R₁ and R₁₆ each represent an alkenyl group, R₁ and R₁₆ each may be, for example, allyl, methacryl or butenyl group. When R₁ represents A-CO— group, which is defined depending on the meaning of A, A-CO— group is a carboxylate group such as acetyl, propionyl, butyryl, capronyl, capryloyl or lauryloyl group. According to the definition in aforesaid Formula (II), R₂ is a para- or a metha-hydroxybenzene group. R₆ and R₇ in the benzyl group is a straight chain or branched alkyl group having a carbon number of 1-9 such as a methyl, ethyl, isopropyl, tertiary butyl, 1,1,3,3-tetrametylbutyl or tertiary nonyl group. R₆ and R₇ are preferably an alkyl group having a carbon number of 1-4 and specifically preferably a methyl or tertiary butyl group.

Depending on the value of n, R₃ is either a monovalent or divalent organic group. When R₃ is an alkyl group having a carbon number of 1-20, R₃ represents, for example, (i) one of the alkyl groups above mentioned for R₁; (ii) a branched chain alkyl group such as an isopropyl, isopentyl, 2-ethylbutyl, 2-ethylhexyl or isononyl group; or (iii) a higher alkyl group such as a n-hexadecyl, n-octadecyl or n-eicosyl group.

When R₃ represents a substituted or interrupted alkyl group, examples of R₃ include: 2-phenoxyethyl, 2-benzoyloxyethyl, 2-p-tolyloxypropyl, cyclohexyloxymethyl, 2,3-di(phenoxy)propyl, 2-phenylthioethyl, 2-(4-tertiary phenylthio)ethyl, 2-acetylethyl, 2-isobutyrylethyl, 2-(dodecylcarbonyl)ethyl, 2-cyanoethyl, cyanomethyl, 3-cyanopropyl, methoxycarbonylmethyl, dodecyloxycarbonylmethyl, 2-ethoxycarbonylethyl, 1,2-di(methoxycarbonyl)propyl, 2,3-di(ethoxycarbonyl)ethyl, 2-(butylaminocarbonyl)ethyl. 2-(cyclohexylcarbonyl)ethyl, 2-(tertiary butyl oxycarbonyl)ethyl, 2-(octadecyloxycarbonyl)propyl, 4-(propoxycarbonyl)butyl, 2-acetoxyethyl, 1,2-diacetoxyethyl, 2-(iso-octanoyloxy)propyl, 2-(octadecanoyloxy)ethyl, 2-(cyclopentylcarbonyloxy)ethyl, 3-benzoyloxypropyl, 2-(p-tertiary butylbenzoyloxy)ethyl, 2-saliciloyloxyethyl, 2-(3,5-di-tertiary butyl-4-hydroxybenzoyloxy)ethyl, 2-phenylacetyloxyethyl, 2-(3,5-di-tertiary butyl-4-hydroxyphenylpropionyloxy)propyl, diethylphosphonomethyl, 2-dimethylphosphonoethyl, 2-(dioctylphosphono)ethyl, diphenylphosphonomethyl, 3-(diallylphosphono)propyl, methoxymethyl, 2-butoxyethyl, 2-octadecyloxyethyl, isopropoxymethyl, 3-butylthiopropyl, 2-dodecylthioethyl, 2-*(isohexylsulfinyl)ethyl, 2-octadecylsulfonylethyl, 2-ethylsulfonylpropyl, 2-(2,2,6,6-tetramethylpiperidine-4-yloxycarbonyl)ethyl, 2-(1,2,2,6,6-pentamethylpiperidine-4-ylaminocarbonyl)ethyl, 2-(2,2,6,6-tetramethylpiperidine-4-yloxycarbonyl-2-(methoxycarbonyl)hexyl or 2,2-bis(2,2,6,6-tetramethylpiperidine-4-yloxycarbonyl)hexyl.

When R₃ represents an alkenyl group is, examples of R₃ include: an allyl, methacryl, 2-butene-1-yl, 3-hexene-1-yl, undecenyl and oleyl group.

When R₃ represents an aralkyl group, examples of R₃ include: a benzyl, 2-phenylpropyl, β-naphthylmethyl, 4-methylbenzyl, 4-tertiary butylbenzyl and 4-methylnaphthyl-1-methyl group.

When R₃ represents —COR₁₆ or —NHCOR₁₆, examples of R₃ include: an acetoxy, propyloxy, butyloxy, octanoyloxy, dodecanoyloxy, benzoyloxy, 3,5-di-tertiary butyl-4-hydroxybenzoyloxy, acetoamino, butyrylamino and decanoylamino group.

When n is 2, R₃ represents a direct bond or a divalent organic group. Examples of R₃ include alkylene groups, for example, a methylene group, an ethylene group and a polymethylene group having a carbon number of not more than 20.

A preferable compound represented by Formula (I) is such a compound in which (i) Ra or Rd is a methyl group; (ii) Re and Rf each is a hydrogen atom; (iii) Ra and Rc each are an ethyl group; (iv) Rb, Rd and Re each are a methyl group; and Rf is a hydrogen atom.

Further, preferable as a compound represented by Formula (I) is such a compound in which:

(a) X is oxygen or NH group;

(b) R₁ represents a hydrogen atom, —O., an alkyl group having a carbon number of 1-4 (preferably an unsubstituted group), for example, an allyl, propagyl, acetyl, acryloyl or chlotonoyl group;

(c) R₂ is a group in which, in Formulas (IIa) and (IIb), R₆ and R₇ each independently represents an alkyl group having a carbon number of 1-4 (preferably a unsubstituted group) and R₈ represents a hydrogen atom or a methyl group; (d) when n=1, R₃ represents one of the following groups:
(i) an alkyl group having 1 to 4 carbon atoms, the alkyl group being substituted with 1 or 2 groups of: a non-substituted alkyl group having 1 to 18 carbon atoms, a —COOR₁₂ group (wherein R₁₂ represents an alkyl group having 1 to 4 carbon atoms or a group represented by Formula (III)), an —OCOR₁₃ group (wherein R₁₃ represents a phenyl group), and a —P(O) (OR₁₄)₂ group (wherein R₁₄ represents an alkyl group having 1 to 4 carbon atoms),
(ii) an alkenyl group having 3 to 6 carbon atoms,
(iii) a phenyl group,
(iv) an aralkyl group of 7 having 15 carbon atoms,
(v) a —OCOR₁₅ group (wherein R₁₅ represent an alkyl group having 1 to 12 carbon atoms, a phenyl group, a 3,5-di-tertiarybutyl-4-hydroxyphenyl group or a 2-(3,5-di-tertiarybutyl)-4-hydroxyphenyl-ethyl group), and
(vi) a —NHCOR₁₆ group (wherein R₁₆ represents an alkyl group having 1 to 12 carbon atoms)

(e) when n=2, R3 represents a direct bond or an alkyl group having a carbon number of 1-12.

Specifically preferable as a compound represented by Formula (I) is such a compound in which:

(a) n represents 1 or 2;

(b) Ra, Rb, Rc and Rd each represent a methyl group;

(c) Re and Rf each represent a hydrogen atom;

(d) X represents an —O— group;

(e) R₁ represents a hydrogen atom, an —O. group, an alkyl group having 1 to 4 carbon atoms, an allyl group, or an acetyl group;

(f) R₂ represents a hydroxybenzyl group represented by Formula (IIa) or Formula (IIb); and

(g) R₃ represents one of the following groups:
(i) an alkyl group having 1 to 18 carbon atoms, the alkyl group being substituted with one or two groups of: a non-substituted alkyl group having 1 to 18 carbon atoms, and a —COOR₁₂ group (wherein R₁₂ represents an alkyl group having 1 to 4 carbon atoms or a group represented by Formula (IIIa)); or a —P(O) (OR₁₄)₂ group (wherein R₁₄ represents an alkyl group having 1 to 4 carbon atoms),
(ii) an ally group,
(iii) a benzyl group,
(iv) a phenyl group,
(V) an alkylene group having 1 to 8 carbon atoms, and
(vi) a xylylene group:
   wherein, in Formulas (IIa) and (IIb), R₆ represents a tertiary butyl group, R₇ represents a methyl group or a tertiary butyl group and R₈ represents a hydrogen atom or a methyl group; and, in Formula (IIIa), R₁ is common to R₁ in Formula (I).

In the present invention, a compound represented by aforesaid Formula (I) is formed by addition of acid of at most an equivalent to a piperidine group, and also includes salt. Such acid includes inorganic acid such as sulfuric acid, hydrochloric acid and phosphoric acid; organic carboxylic acid such as formic acid, acetic acid, oxalic acid, maleic acid, benzoic acid and salicylic acid; organic sulfonic acid such as m- or p-toluenesulfonic acid and methanesulfonic acid; or organic phosphor containing acid such as diphenylphosphoric acid and diphenylphosphinic acid.

Compounds represented by Formula (I) will be shown below, however, the present invention is not limited thereto.

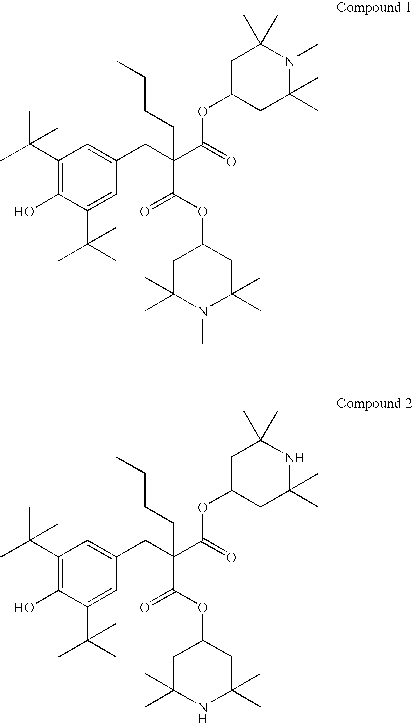

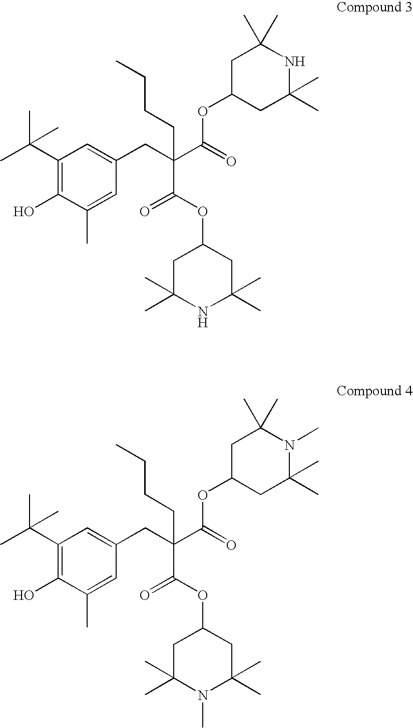

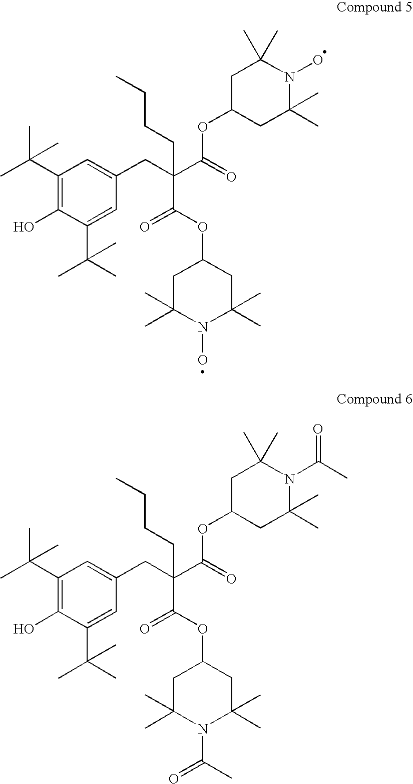

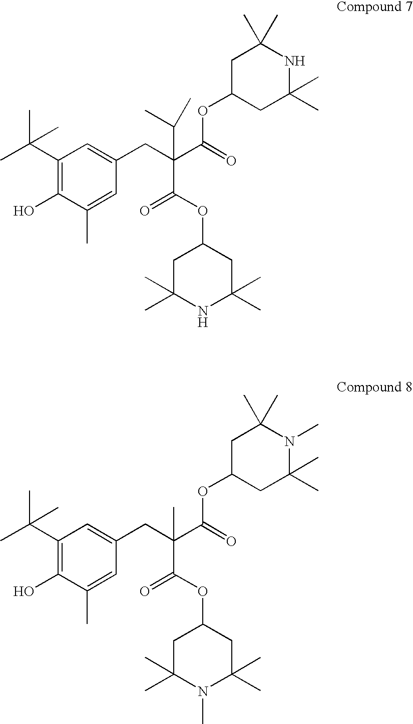

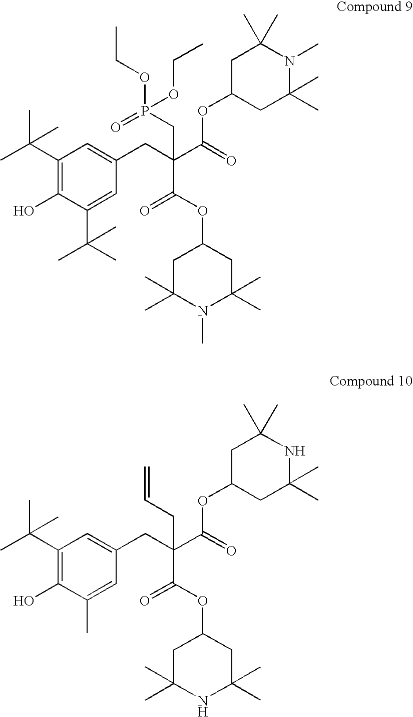

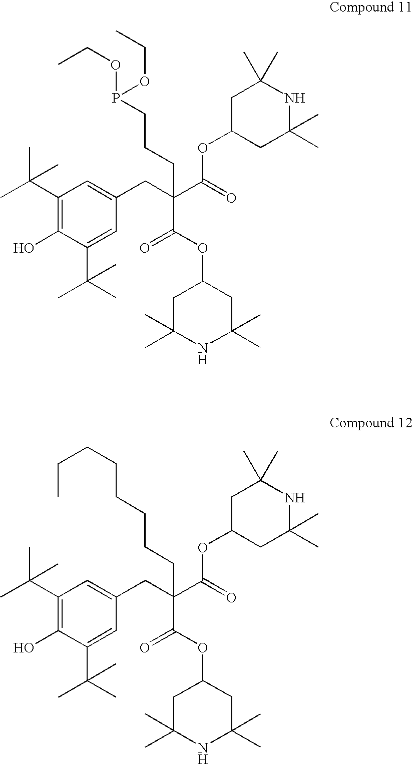

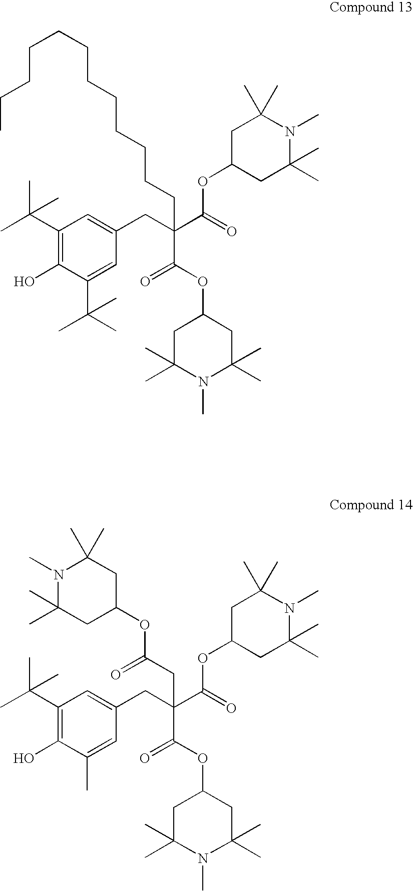

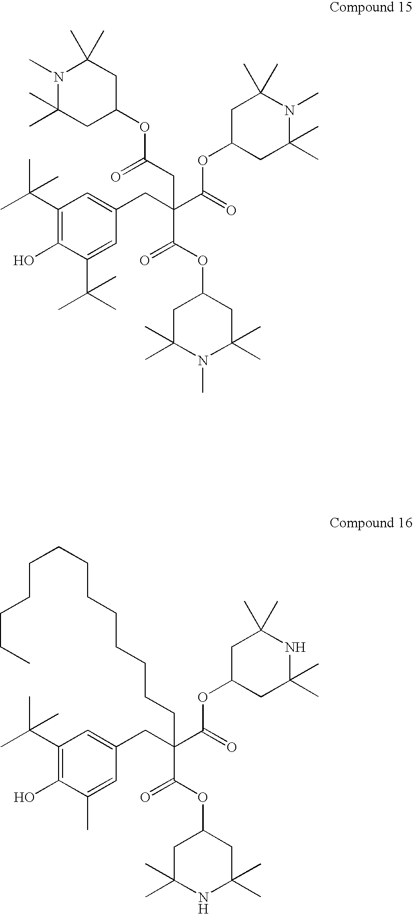

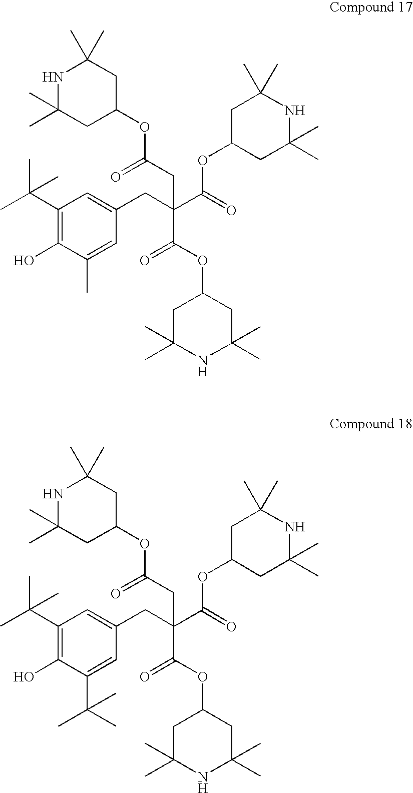

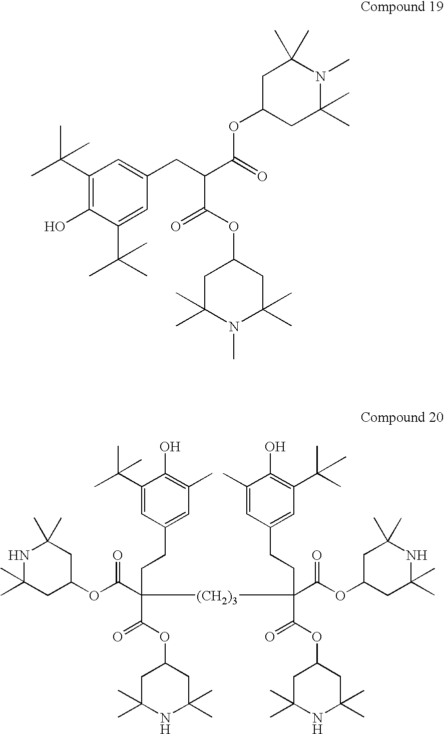

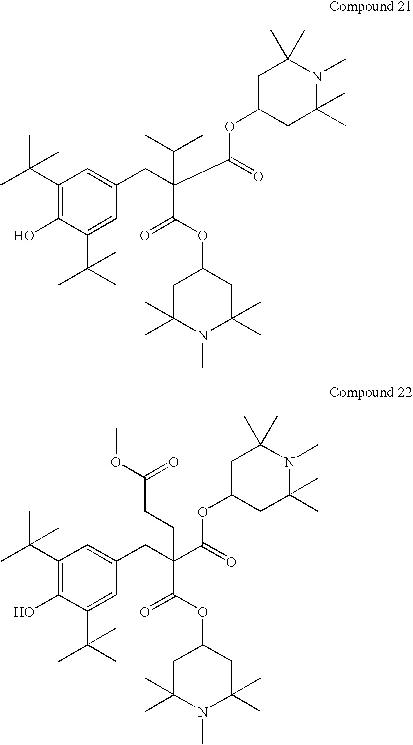

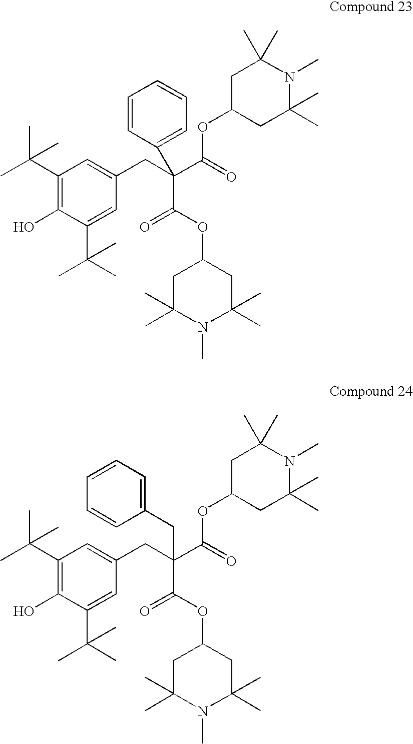

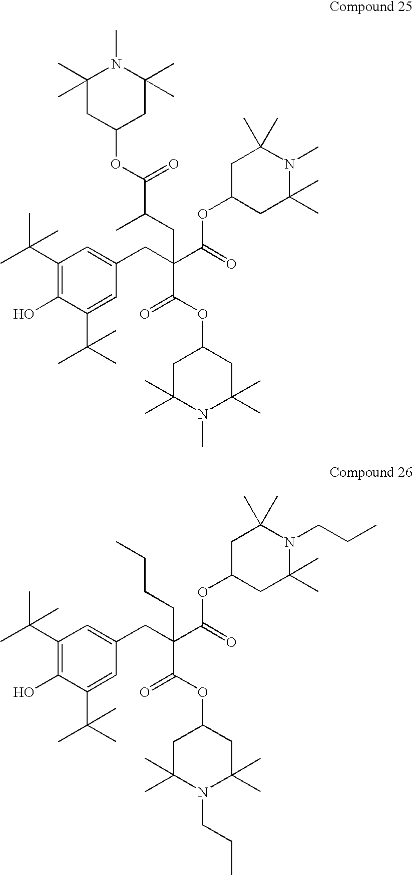

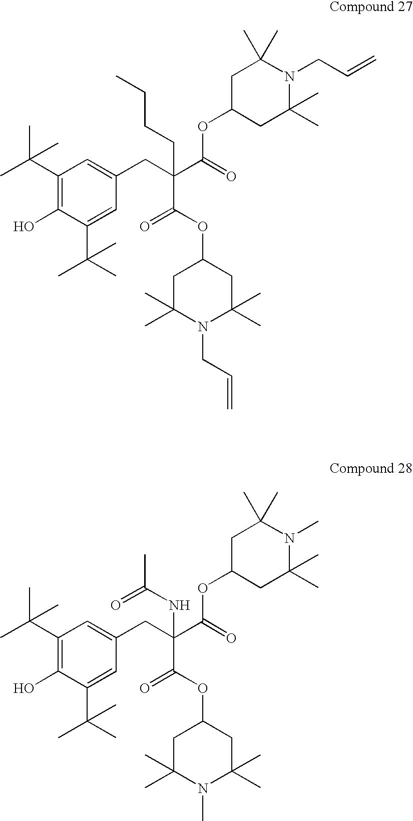

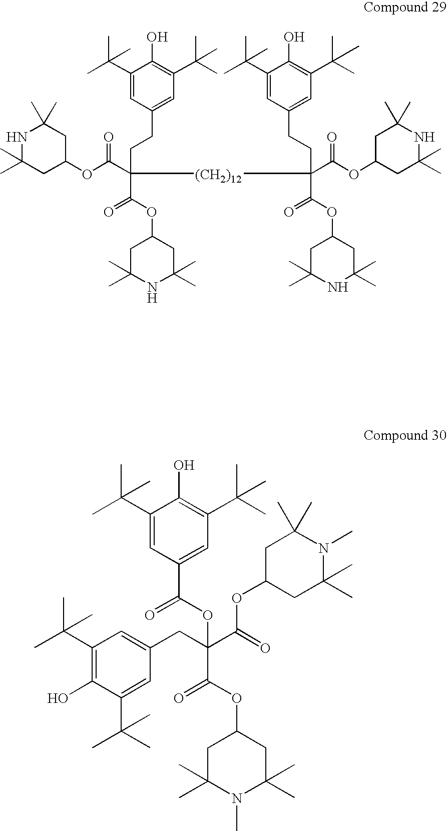

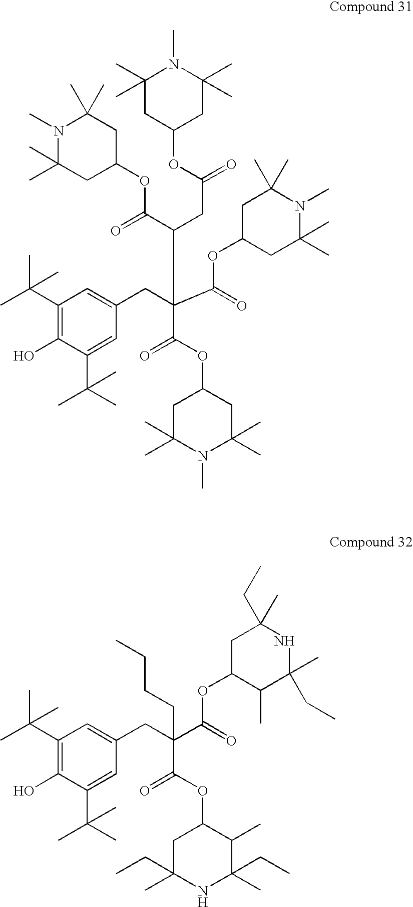

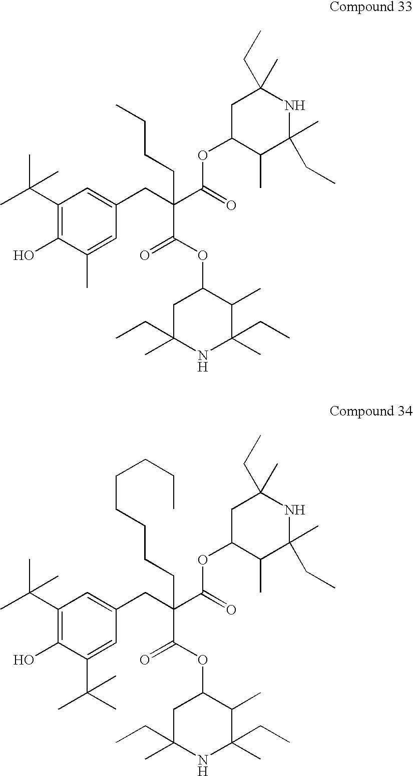

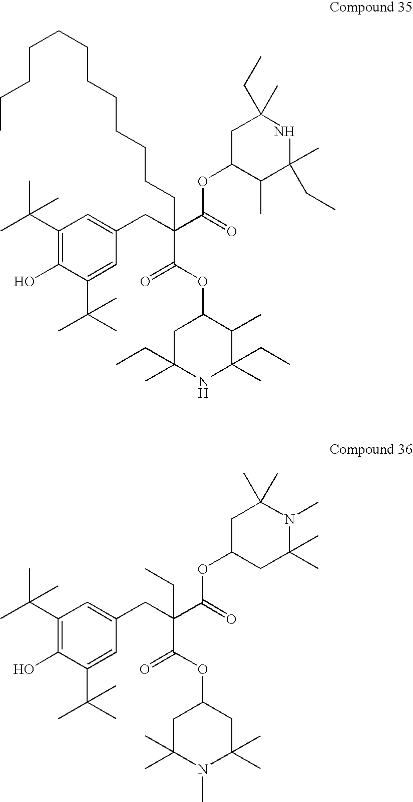

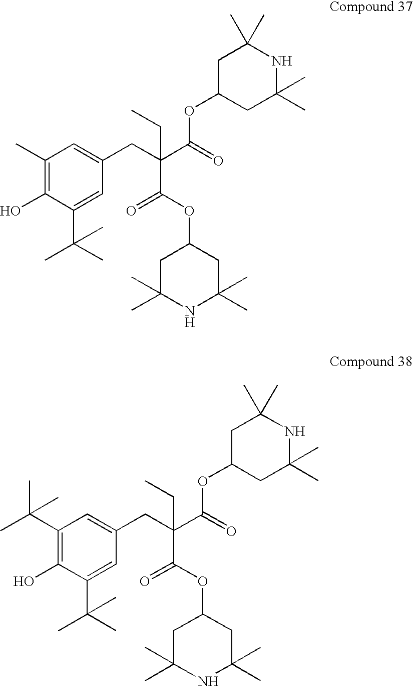

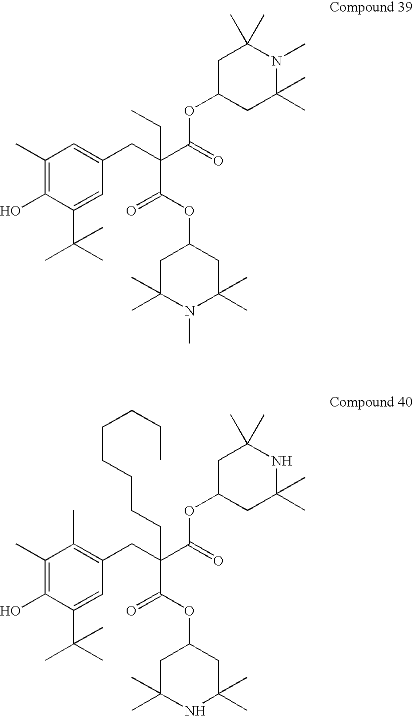

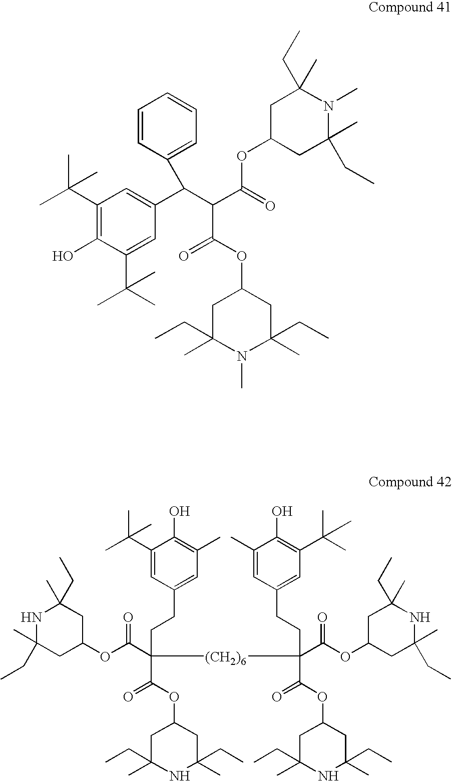

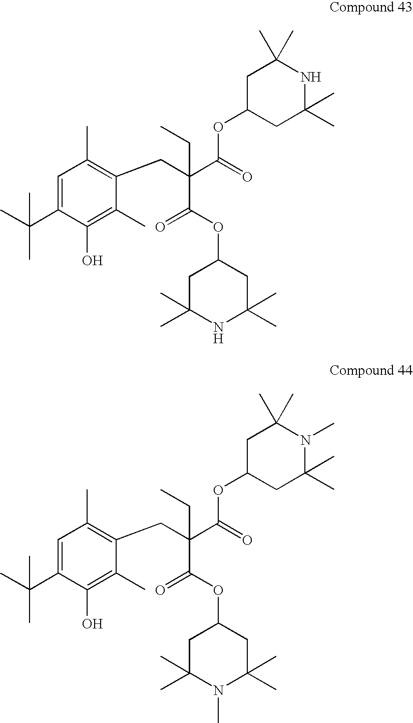

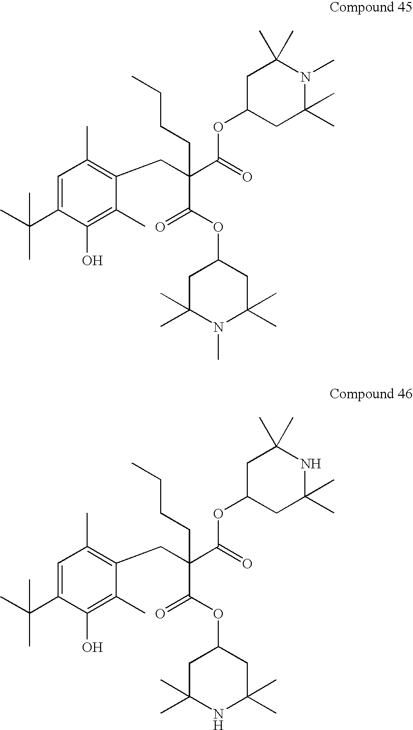

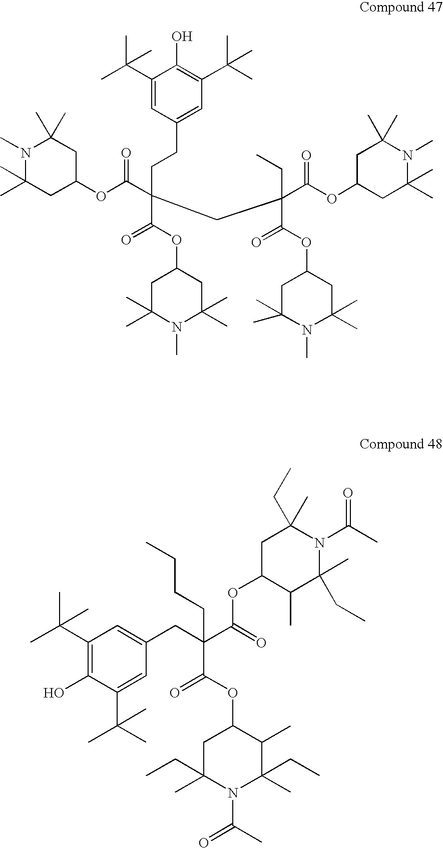

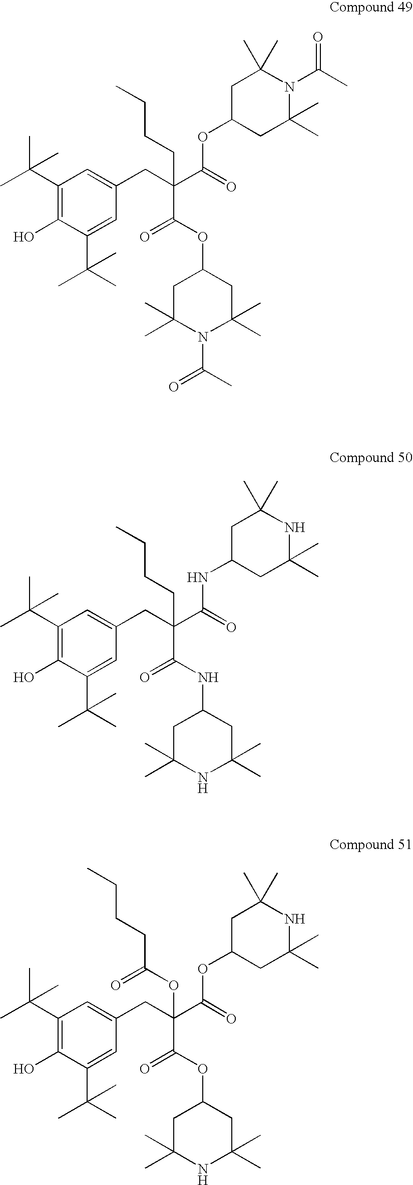

Synthesis of a compound according to the present invention represented by aforesaid Formula (I) is initiated by reacting a lower alkyl malonic ester such as diethylmalonate with 4-piperidinol or 4-aminopiperidine, which is represented by (IV), to be converted into a corresponding bispiperidinyl malonic acid derivative (V) as shown below. Herein, introduction of R₁ can be performed by an ordinary method of N-alkylation or N-acylation such as a method in which alkylhalide, alkenylhalide or carboxylic chloride is reacted in the presence of not more than 1 mol of base.

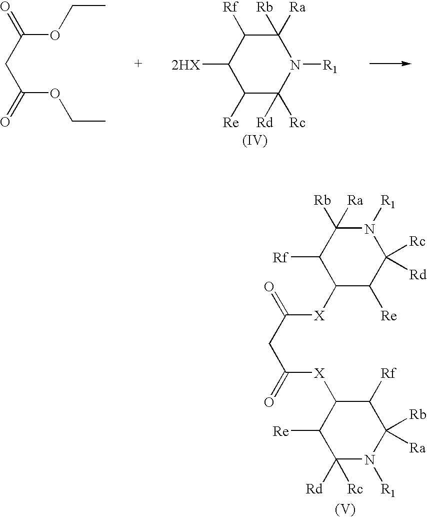

Next introduction of hydroxybenzyl group R₂ is performed by a reaction with hydroxybenzyl dithiocarbamate, which is represented by R₂—S—CS—N(R)₂ (R represents an alkyl group having a carbon number of 1-5 or both R represent a morpholine, pyrrolidine or piperidine ring together with a nitrogen atom.). Such dithiocarbamate can be obtained by reacting phenol with formaldehyde, carbon disulfide and secondary amine.

Another introduction method of hydroxybenzyl group R₂ is comprised of a reaction with hydroxybenzylamine R₂—N(R)₂-Such amine can be obtained by reacting phenol with formaldehyde and secondary amine by so-called Mannich reaction.

When X is an oxygen atom, R₂ is introduced by a malonic ester synthesis method in which ester (IV) is initially reacted with 1 equivalent of alkali metal, alkali alcolato, alkaliamido or alkali hydride or with a similar basic alkali compound to be converted into alkali compound (V), which is subsequently reacted with 1 mol of hydroxybenzyl halide (R₂-Hal, Hal: Cl, Br or I) by an ordinary method.

A hydroxybenzylmalonic acid derivative represented by (VI) described below is manufactured by any one of the above-described three methods and subsequently R₃ is introduced into said derivative.

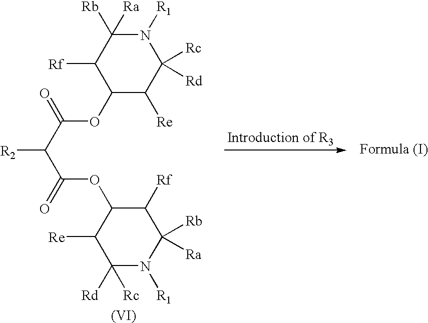

Introduction of R₃ is performed by a conventional method of C-alkylation of malonic ester in which (VI) is initially converted to an alkali compound thereof and said compound is reacted with halogen compound R₃Hal or R₃Hal₂.

### SYNTHESIS EXAMPLE

### Synthesis of Compound 31

Butylmalonic bis(1,2,2,6,6-pentamethyl-4-piperidinyl)ester of 23.3 g (0.05 mol) and N-(3,5-di-tertiary butyl-4-hydroxybenzyl)dimethylamine of 13.2 g (0.05 mol) are dissolved in 200 ml of toluene. After 0.25 g of lithium amide are added into the resulting solution, the mixture is refluxed for 4 hours. After cooling, the mixture is neutralized with 1.5 ml of 1% acetic acid, and the organic phase is repeatedly washed with water. The resulting organic solution is dried with Na₂SO₄, followed by being concentrated under reduced pressure, whereby compound 31 can be prepared. Melting point: 140° C.

Other example compounds can be prepared in a similar manner.

The addition amount of a compound represented by Formula (I) against cellulose ester is generally 0.001-10.0 weight parts, preferably 0.01-5.0 weight parts and furthermore preferably 0.1-3.0 weight parts, with respect to one type of a compound, against 100 weight parts of cellulose ester.

(Cellulose Ester)

The cellulose ester of the present invention is a single or mixed acid ester of cellulose which has a cellulose ester structure including at least one of a fatty acid acyl group or a substituted or unsubstituted aromatic acyl group.

Examples of the benzene ring substituent group when the aromatic ring in the aromatic acyl group is a benzene ring include, a halogen atom, a cyano group, an alkyl group, a cycloalkyl group, an alkoxy group, and aryl group, an aryloxy group, an acyl group, a carbonamide group, a sulfonamide group, a ureido group, an aralkyl group, a nitro group, an alkoxy carbonyl group, an aryloxy carbonyl group, an aralkyoxy carbonyl group, a carbamoyl group, a sulfamoyl group, an acyloxy group, an alkenyl group, an alkinyl group, an alkyl sulfonyl group, an aryl sulfonyl group, an alkyloxy sulfonyl group, an aryloxy sulfonyl group, an alkyl sulfonyloxy group, and an aryloxy sulfonyl group, —S—R, —NH—CO—OR, —PH—R, —P(—R)₂, —PH—O—R, —P(—R) (—O—R), —P(—O—R)₂, —PH(═O)—R—P(═O) (—R)₂, —PH(═O)—O—R, —P(═O) (—R) (—O—R), —P(═O) (—O—R)₂, —O—PH(═O)—R, —O—P (═O) (—R)₂—O—PH(═O)—O—R, —O—P(═O) (—R)(—O—R), —O—P(═O) (—O—R)₂, —NH—PH(═O)—R, —NH—P(═O) (—R) (—O—R), —NH—P(═O) (—O—R) 2, —SiH₂—R, —SiH(—R)₂, —Si(—R)₃, —O—SiH₂—R, —O—SiH(—R)₂ and —O—Si(—R)₃. R above is a fatty acid group, an aromatic group, or a heterocyclic group. The number of substituent groups is preferably between 1 and 5, more preferably between 1 and 4 and still more preferably between 1 and 3, and most preferably either 1 or 2. Examples of the substituent group preferably include a halogen atom, cyano, an alkyl group, an alkoxy group, an aryl group, an aryloxy group, an acyl group, a carbonamide group, a sulfonamide group, and a ureido group, and more preferably, a halogen atom, cyano, an alkyl group, an alkoxy group, an aryloxy group, an acyl group, and a carbonamide group, and still more preferably, a halogen atom, cyano, an alkyl group, an alkoxy group, and an aryloxy group, and most preferably, a halogen atom, an alkyl group, and an alkoxy group.

Examples of the halogen atom include a fluorine atom, a chlorine atom, a bromine atom, and an iodine atom. The alkyl group may have ring structure or may be branched. The number of carbon atoms in the alkyl group is preferably 1-20, more preferably 1-12, still more preferably 1-6, and most preferably 1-4. Examples of the alkyl group include methyl, ethyl, propyl, isopropyl, butyl, t-butyl, hexyl, cyclohexyl, octyl and 2-ethyl hexyl. The alkoxy group may have ring structure or may be branched. The number of carbon atoms in the alkoxy group is preferably 1-20, more preferably 1-12, still more preferably 1-6, and most preferably 1-4. The alkoxy group may be further substituted by another alkoxy group. Examples of the alkoxy group include a methoxy, ethoxy, 2-methoxyethoxy, 2-methoxy-2-ethoxyethoxy, butyloxy, hexyloxy and octyloxy.

The number of carbon atoms in the aryl group is preferably 6-20, and more preferably 6-12. Examples of the aryl group include phenyl and naphtyl. The number of carbon atoms in the aryloxy group is preferably 6-20, and more preferably 6-12. Examples of the aryloxy group include phenoxy and naphtoxy. The number of carbon atoms in the acyl group is preferably 1-20, and more preferably 1-12. Examples of the acyl group include hormyl, acetyl, and benzoyl. The number of carbon atoms in the carbonamide group is preferably 1-20, and more preferably 1-12. Examples of the carbonamide include acetoamide and benzamide. The number of carbon atoms in the sulfonamide group is preferably 1-20, and more preferably 1-12. Examples of the sulfonamide include methane sulfonamide, benzene sulfonamide, and p-toluene sulfonamide. The number of carbon atoms in the ureido group is preferably 1-20, and more preferably 1-12. Examples of the ureido group include (unsubstituted) ureido.

The number of carbon atoms in the aralkyl group is preferably 7-20, and more preferably 7-12. Examples of the aralkyl group include benzyl, phenethyl, and naphtyl methyl. The number of carbon atoms in the alkoxycarbonyl group is preferably 1-20, and more preferably 2-12. Examples of the alkoxycarbonyl group include methoxy carbonyl. The number of carbon atoms in the aryloxy carbonyl group is preferably 7-20, and more preferably 7-12. Examples of the aryloxy carbonyl group include phenoxy carbonyl. The number of carbon atoms in the aralkyloxycarbonyl is preferably 8-20, and more preferably 8-12. Examples of the aralkyoxycarbonyl include benzyloxycarbonyl. The number of carbon atoms in the carbamoyl group is preferably 1-20, and more preferably 1-12. Examples of the carbamoyl group include (unsubstituted) carbamoyl and N-methyl carbamoyl. The number of carbon atoms in the sulfamoyl group is preferably no greater than 20, and more preferably no greater than 12. Examples of the sulfamoyl group include (unsubstituted) sulfamoyl and N-methyl sulfamoyl. The number of carbon atoms in the acyloxy group is preferably 1-20, and more preferably 2-12. Examples of the acyloxy group include acetoxy and benzoyloxy.

The number of carbon atoms in the alkenyl group is preferably 2-20, and more preferably 2-12. Examples of the alkenyl group include vinyl, aryl and isopropenyl. The number of carbon atoms in the alkinyl group is preferably 2-20, and more preferably 2-12. Examples of the alkinyl group include dienyl. The number of carbon atoms in the alkyl sulfonyl group is preferably 1-20, and more preferably 1-12. The number of carbon atoms in the aryl sulfonyl group is preferably 6-20, and more preferably 6-12. The number of carbon atoms in the alkyloxy sulfonyl group is preferably 1-20, and more preferably 1-12. The number of carbon atoms in the aryloxy sulfonyl group is preferably 6-20, and more preferably 6-12. The number of carbon atoms in the alkyl sulfonyloxy group is preferably 1-20, and more preferably 1-12. The number of carbon atoms in the aryloxy sulfonyl is preferably 6-20, and more preferably 6-12.

In the cellulose ester of the present invention, in the case where the hydrogen atom of the hydroxyl group portion of the cellulose is a fatty acid ester with a fatty acid acyl group, the number of carbon atoms in the fatty acid acyl group is 2-20, and specific examples thereof include acetyl, propionyl, butyryl, isobutyryl, valeryl, pivaroyl, hexanoyl, octanoyl, lauroyl, stearoyl and the like.

The fatty acid acyl group of the present invention also refers to one which is further substituted, and examples of the benzene ring substituent group include those given as examples when the aromatic ring in the aromatic acyl group is a benzene ring.

When the esterified substituent group of cellulose ester is an aromatic ring, the number of the substituent groups X which are substituted on the aromatic ring should be 0 or 1-5, preferably 1-3, and 1 or 2 is particularly preferable. In addition, when the number of substituent groups substituted on the aromatic ring is 2 or more, the substituent groups may be the same or different from each other, and they may also bond with each other to form a condensed polycylic compound (such as naphthalene, indene, indan, phenanthrene, quinoline, isoquinilene, chromene, chromane, phthalazine, acridine, indole, indolin and the like).

The structure used in the cellulose ester of the present invention has a structure selected from at least one of a substituted or unsubstituted fatty acid acyl group or a substituted or unsubstituted aromatic acyl group, and these may be a single cellulose or a mixed acid ester, and two or more types of cellulose esters may be mixed and used.

The cellulose ester used in the present invention is preferably at least one type selected from cellulose acetate, cellulose propionate, cellulose butyrate, cellulose acetate propionate, cellulose acetate butyrate, cellulose acetate phthalate and cellulose phthalate.

In terms of the degree of substitution for the mixed fatty acid ester, the short chain fatty acid ester of the cellulose acetate propionate, and cellulose acetate butyrate which are most preferable, have an acyl group having 2-4 carbon atoms as the substituent group, and given that the substituent group for the acetyl group is represented by X and the substituent group for the propionyl group or the butyryl group is represented by Y, the cellulose resin includes cellulose esters which simultaneously satisfy both Equation (I) and Equation (II) below.
2.6≦X+Y≦3.0 Equation (1)
0≦X≦2.5 Equation (II)

Cellulose acetate propionate is preferably used herein, and of the cellulose acetate propionates, those that satisfy 1.9≦X≦2.5 and 0.1≦Y≦0.9 are particularly preferable. The portion of the acyl group that is not substituted is usually a hydroxyl group. These may be synthesized by a known method.

In the cellulose ester used in the present invention, the ratio of the weight average molecular weight Mw/number average molecular weight Mn is preferably 1.5-5.5, while 2.0-5.0 is particularly preferable, 2.5-5.0 is more preferable and 3.0-5.0 is even more preferable.

The cellulose which is the raw material for the cellulose ester of the present invention may be wood pulp or cotton linter, and the wood pulp may be that of a needle-leaf tree or a broad-leaf tree, but that of the broad-leaf tree is more preferable. Cotton linter is preferably used in view of peeling properties at the time of film formation. Cellulose esters made from these substances may be suitably blended or used alone.

For example, the proportion used of cellulose ester from cotton linter: cellulose ester from wood pulp (needle-leaf tree): cellulose ester from wood pulp (broad-leaf tree) may be 100:0:0, 90:10:0, 85:15:0, 50:50:0, 20:80:0, 10:90:0, 0:100:0, 0:0:100; 80:10:10, 85:0:15, and 40:30:30.

(Inclusion of Additives)

One or more types of additives is included in the cellulose ester having a water content not greater than 5.0 weight % (preferably not grater than 3.0 weight %) of the present invention prior to heat melting.

In the invention, including the additive does not only refer to the additive being enclosed by the cellulose ester, but also refers to the additive being present on the inside and the outer surface simultaneously.

The methods for including the additive include one in which the cellulose ester is dissolved in a solvent, and then the additive is dissolved or dispersed in the resultant solution, and then the solvent is removed. Known methods are used to remove the solvent, and examples thereof include the liquid drying method, the air drying method, the solvent co-precipitation method, the freeze-drying method, and the solution casting method. The mixture of the cellulose ester and the additive after the removal of the solvent can be prepared so as be in the form of a fine particles, granules, pellets, a film or the like. The inclusion of the additive is performed by dissolving solid cellulose ester as described above, but this may be performed simultaneously with deposition and hardening in the step of synthesizing the cellulose ester.

An example of the liquid drying method is one in which an aqueous solution of an activating agent such as sodium lauryl sulfate is added to a solution in which the cellulose ester and the acid are dissolved and an emulsion and dispersion is performed. Next, the solvent is removed by normal pressure or low pressure distillation, and a dispersant of the cellulose ester having the additive included therein is thereby obtained. In addition, centrifugal separation or decantation is preferably performed in order to remove the active agent. Various methods may be used as the emulsification method, and emulsification device using supersonic waves, high-speed rotational shearing and high pressure may be used.

In the emulsification and dispersion method using ultrasonic waves, a so-called batch method and continuous method may be used. The batch method is suitable for preparation of comparatively small amounts of sample, while the continuous method is suitable for large amounts of sample. In the continuous method, a device such as the UH-600SR (manufactured by SMT Co., Ltd.) may be used. In the case of the continuous method, the amount of time for the irradiation of the supersonic waves can be determined by the capacity of the dispersion chamber/flow rate x circulation frequency. In the case where there is more than one supersonic irradiation device, the total of each irradiation time is determined. The irradiation time for the supersonic-waves is no more than 10,000 seconds. Also, if the irradiation time needs to be greater than 10,000 seconds, the processing load becomes large, and the actual emulsion dispersion time must be made shorted be re-selecting the emulsifying agent or the like. As a result, a time exceeding 10,000 seconds is not necessary. It is more preferable that the time is between 10 and 2,000 seconds.

A disperser mixer, a homogenizer, an ultra mixer or the like may be used as the emulsion and dispersion device which uses high-speed rotational shearing, and the viscosity of the liquid at the time of emulsion and dispersion can determine which type of device is used.

For emulsion and dispersion using high pressure, LAB 2000 (manufactured by SMT Co., Ltd.) may be used, but the emulsion and dispersion capability depends on the pressure that is applied to the sample. Pressure in the range of 10⁴-5×10⁵ kPa is preferable.

Examples of the active agent that may be used include a cation surface active agent, an anion surface active agent, an amphoteric surface active agent and a polymer dispersing agent. The active agent used is determined by the solvent and the particle diameter of the target emulsion.

The air drying method is one in which a spray dryer such as GS310 (manufactured by Yamato Scientific Co., Ltd.) is used, and a solution in which the cellulose ester and the additive are dissolved is sprayed.

The solvent co-precipitation method is one in which a solution in which the cellulose ester and the additive are dissolved is added to a poor solvent of the cellulose ester and the additive and then precipitation takes place. The poor solvent may be optionally blended with the solvent which dissolves the cellulose ester. The poor solvent may also be a mixed solvent. The poor solvent may also be added to a solution of the cellulose and the additive.

The mixture of the precipitated cellulose ester and the additive can be filterred and dried to separate.

In the mixture of the cellulose ester and the additive, the particle diameter of the additive is no greater than 1 μm and preferably no greater than 500 nm, and still more preferably no greater than 200 nm. The smaller the particle size of the additive, the more even the distribution of the mechanical strength and the optical properties of the melt cast, and thus a small particle size is favorable.

It is preferable that the mixture of the cellulose ester and the additives as well as the additives added at the time of heat melting are dried prior to or during heat melting. Drying herein refers to removing the water adsorbed by any of the melting materials, in addition to either the water or solvent used preparing the cellulose ester and additive mixture or the solvent introduced when preparing the additive.

The removal method may be any known drying method, and examples include the heating method, the pressure reduction method, the heating and pressure reduction method and the like, and may be performed in the air or in an inert gas environment with nitrogen selected as the inert gas. In view of film quality, it is preferable that these known drying methods are performed in a temperature range where the materials do not decompose.

For example, the moisture or solvent remaining after removal in the drying step is no greater than 10 weight % of the total weight of the materials comprising the film, and preferably no greater than 5 weight % and more preferably no greater than 1 weight %, and still more preferably no greater than 0.1 weight %. The drying temperature at this time is preferably between 100° C. and the Tg of the material to be dried. In view of preventing the materials from adhering to each other the drying temperature is preferably between 100° C. and the (Tg-5)° C. and more preferably between 110° C. and the (Tg-20)° C. The drying time is preferably 0.5-24 hours, and more preferably 1-18 hours and still more preferably 1.5-12 hours. If the drying time is less than these ranges, the level of drying will be low or the drying will take too much time. Also, if the material to be dried has a Tg, if it is heated to a drying temperature that is higher than Tg, the material melts and handling is difficult.

The drying stage may be separated into 2 or more stages. For example the melt film may be prepared via storage of the material using a preliminary drying step and a pre-drying step which is performed directly before to one week before the melt layer is prepared.

(Additives)

Examples of the additives for the cellulose ester of the present invention include at least one type of a polyalcohol and a monocarboxylic acid, an ester plasticizer formed from a polycarboxylic acid and a monoalcohol, a hindered phenol antioxidant, a hindered amine light stabilizer, and an acid scavenger. Other additives that may be included are peroxide compounds, radical scavengers, metal deactivators, ultraviolet light absorbers, matting agents, dyes, pigments, and plasticizers other than those described above, and antioxidants other than the hindered phenol antioxidants described above.

Additives are used to trap material generated when the materials composing the film are subjected to anti-oxidation and decomposition; to control or prevent the decomposition reaction caused by radicals due to heat or light as well as decomposition reactions of an unknown source; and to control generation of volatile components due to changed in quality typified by coloration and reduction in molecular weight.

On the other hand, when the materials comprising the film are melted using heat, the decomposition reaction is outstanding and deterioration in strength of the materials sometimes occurs due to coloration or reduction in molecular weight due to the decomposition. Generation of undesirable volatile components also occurs due to the decomposition reaction of the materials composing the film.

When the materials composing the film are melted using heat, the presence of the above-described additives is favorable because this controls deterioration of strength due to decomposition of the material, and also in view of the fact that characteristic strength of the material can be maintained. The foregoing additives must be present in order to produce the optical film of the present invention.

In addition, the presence of the foregoing additives at the time of heat melting is favorable in that the creation of coloration in the visible region is controlled and also undesirable properties for the optical film such as transmissitivity or haze value caused by mixing of volatile components in the film can be controlled.

The displayed image of the liquid crystal display device of the present invention is affected if haze exceeds 1% when the optical film having the structure of the present invention is used, and thus the haze value is preferably less than 1% and more preferably less than 0.5%.

When the film is being produced, the step for providing retardation depends on controlling the deterioration in strength of the materials composing the film or maintaining the material characteristic of the film. This is because if the materials comprising the film become brittle due to extreme deterioration, breakage is likely to occur in the stretching step, and as a result it becomes impossible to control the retardation value.

A deterioration reaction due the oxygen in the air may occur during storage of the foregoing materials composing the film or during the film preparation step. In this case, the stabilizing effects of the foregoing additives and the effect of reducing the oxygen concentration in the air may be used together in realizing the present invention. Examples of known techniques include using nitrogen or argon as the inert gas; degasification using conditions varying from reduced pressure to a vacuum; and an operating in an airtight environment. At least one of these three methods can be used in the presence of the foregoing additives. By decreasing the likelihood that oxygen in the air adheres to the material composing the film, deterioration of the material is controlled and this is favorable for achieving the object of the present invention.

It is also favorable that the foregoing additives are present in the materials composing the film, in view of improving storage properties over time for the polarizing plate and the polarizer, comprising the polarizing plate of the present invention, in order for the optical film of the present invention to be used as a polarizing plate protective film.

In the liquid crystal display device using the polarizing plate of the present invention, because the foregoing additives are present in the optical film of the present invention, the storage properties of the optical film over passage of time is improved in view of control of the foregoing changes in quality or deterioration, and at the same time, the additives exhibit an excellent effect in improving the display quality of the liquid crystal display device, since the optical compensation design of the optical film can function over an extended period.

(Ester Plasticizer Formed from a Polyalcohol and a Monocarboxylic Acid, and Ester Plasticizer Formed from a Polycarboxylic Acid and a Monoalcohol)

Adding compounds generally known as plasticizers is favorable in view of modifying the film since it improves functional properties, imparts flexibility and resistance to water absorption, and reduces water transmittance. Also, in the heat casting method of the present invention, the plasticizer is added to reduce the melting temperature of the materials composing the film to be lower than the respective glass transition temperature of the cellulose ester used. Also, at the same heating temperature, the viscosity of the materials composing the film including the plasticizer can be reduced to be less than that of the cellulose ester. In the present invention, the melting temperature for the materials composing the film refers to the temperature at which the materials become liquid when the materials are sufficiently heated.

If the cellulose ester by itself is at a temperature that is less than its glass transition temperature, the fluid state for film formation is not exhibited. However, at a temperature higher than the glass transition temperature, the modulus of elasticity or the viscosity is reduced due to absorption of heat, and the fluid state is exhibited. In order to melt the materials composing the film, it is preferable that the plasticizer that is added has a melting point or glass transition temperature that is lower than the glass transition temperature of the cellulose ester in order to fulfill the above-cited objective. Further, it is preferable that the ester plasticizer formed from polyalcohol and a monocarboxylic acid and the ester plasticizer formed from a polycarboxylic acid and a monoalcohol have a high affinity for the cellulose ester.

The present invention uses one or both of an ester plasticizer formed from a polyalcohol and a monocarboxylic acid and an ester plasticizer formed from a polycarboxylic acid and a monoalcohol.

Specific examples of an ethylene glycol ester plasticizer of a polyhydric ester plasticizer include; ethylene glycol alkyl ester plasticizers such as ethylene glycol acetate, ethylene glycol butyrate and the like; ethylene glycol dicycloalkyl ester plasticizers such as ethylene glycol dicyclopropyl carboxylate, and ethylene glycol dicyclohexyl carboxylate; and ethylene glycol aryl ester plasticizers such as ethylene glycol dibenzoate, and ethylene glycol di-4-methyl benzoate. These alkylate groups, cycloalkylate groups and arylate groups may be the same or different and may further be substituted. The substituent groups may be a mix of alkylate groups, cycloalkylate groups and arylate groups, and the substituent groups may be bonded to each other by covalent linkage. Further, the ethylene glycol portions may be substituted and the ethylene glycol ester part of the structure may be part of the polymer or may be systematically included as a pendant. It may also be introduced into a part of the molecular structure of the additive such as an antioxidant, a acid scavenger, and a ultraviolet light absorber.

Examples of a glycerin ester plasticizer, which is a polyalcohol ester plasticizer, include glycerin alky esters such as triaceetin, tributylin, glycerin diacetate carboxylate, and glycerin oleate propionate; glycerin cycloalkyl esters such as glycerin tricyclopropyl carboxylate, and glycerin tricyclohexyl carboxylate; glycerin aryl esters such as glycerin tribenzoate, and glycerin 4-methylbenzoate; diglycerin alkyl esters such as diglycerin tetraacetylate, diglycerin tetrapropionate, digylcerin acetate tricarboxylate, and diglycerin tetralaurate; diglycerin cycloalkyl esters such as diglycerin tetracylobutyl carboxylate, and diglycerin tetracylopentyl carboxylate; and diglycerin aryl esters such as diglycerin tetrabenzoate, and diglycerin 3-methyl benzoate. These alkylate groups, cycloalkyl carboxylate groups and arylate groups may be same or different and may further be substituted. The substituent groups may be a mix of alkylate groups, cycloalky carboxylate groups and arylate groups, and the substituent groups may be bonded to each other by common bonds. Further, the glycerin and diglycerin portions may be substituted and the glycerin ester or diglycerin ester part of the structure may be a part of the polymer or may be systematically included as a pendant. It may also be introduced into a part of the molecular structure of the additive such as the antioxidant, the acid scavenger, and the ultraviolet light absorber. The ester plasticizer formed from a polyalcohol and a monocarboxylic acid preferably contains a polyalcohol having 5 or more carbon atoms. Also, the ester plasticizer formed from a polyalcohol and a monocarboxylic acid preferably has a carboxylic acid moiety containing an aromatic ring, and the total number of aromatic rings contained in the molecule is preferably 3 or more.

Other examples of other polyhdric alcohol ester plasticizers are given in JP-A 2003-12823 from paragraphs 30-33.

These alkylate groups, cycloalkyl carboxylate groups and arylate groups may be same or different and may be further substituted. The alkylate groups, cycloalky carboxylate groups and arylate groups may be mixed, and the substituent groups may be bonded to each other by common bonds. Furthermore, the polyalcohol portion may be substituted and polyalcohol part of the structure may be a part of the polymer or may be systematically included as a pendant. It may also be introduced into a part of the molecular structure of the additive such as the antioxidant, the acid scavenger the ultraviolet light absorber and the like.

Of the ester plasticizers formed from a polyalcohol and a monocarboxylic acid, alkyl polyalcohol aryl esters are preferable; specific examples include ethylene glycol benzoate, glycerin tribenzoate, diglycerin tetrabenzoate and compound 16 which is given as an example in paragraph 32 of JP-A 2003-12823.

Specific examples of the carboxylic acid ester plasticizer which is a polycarboxylic acid ester plasticizer include alkyl dicarboxylic acid alkyl ester plasticizers such as didodecyl moranate (C1), dioctyl adipate (C4), dibutyl cevacate (C8) and the like; alkyl dicarboxylic acid cycloalkyl ester plasticizers such as dicyclopentyl succinate, dicyclohexyl adipate and the like; alkyl dicarboxylic acid aryl ester plasticizers such as diphenyl succinate, di-4-methyl phenyl glutarate and the like, cycloalkyl dicarboxylic acid alkyl ester plasticizers such as dihexyl-1,4-cyclohexane dicarboxylate, didecyl bicyclo [2.2.1]heptane-2,3-dicarboxylate and the like; cycloalkyl dicarboxylic acid dicycloalkyl ester plasticizers such as dicyclohexyl-1,2-cyclobutane dicarboxylate, dicyclopropyl-1, 2-cyclohexyl dicarboxylate and the like; cycloalkyl dicarboxylic acid aryl ester plasticizers such as diphenyl 1, 1-cyclopropyl dicarboxylate, di 2-naphtyl-1,4-cyclohexane dicarboxylate and the like; aryl dicarboxylic acid alkyl ester plasticizers such as diethyl phthalate, dimethyl phthalate, dioctyl phthalate, dibutyl phthalate, di-2-ethyl hexyl phthalate and the like; aryl dicarboxylic acid cycloalkyl ester plasticizers such as dicyclopropyl phthalate, dicyclohexyl phthalate and the like; and aryl carboxylic acid aryl ester plasticizers such as diphenyl phthalate, di-4-methyl phenyl phthalate and the like. These alkoxy groups and cycloalkoxy groups may be the same or different, and may also be substituted and the substitution groups may be further substituted. The alkyl groups and the cycloalkyl groups may be mixed, and the substituent groups may be bonded to each other by common bonds. Furthermore, the aromatic ring of the phthalic acid may be substituted and may be polymer such as a dimer, trimer, tetramer and the like. The phthalic acid ester part of the structure may be a part of the polymer or may be systematically included as a pendant. It may also be introduced into a part of the molecular structure of the additive such as the antioxidant, and the acid scavenger the ultraviolet light absorber.

The amount of an ester plasticizer formed from a polyalcohol and a monocarboxylic acid or an ester plasticizer formed from a polycarboxylic acid and a monoalcohol incorporated in cellulose ester is preferably 0.1 to 50 weight parts, more preferably 1 to 30 weight parts, and still more preferably 3 to 15 weight parts in 100 weight parts of cellulose ester.

Specific examples of other polycarboxylic acid ester plasticizers include alkyl polycarboxylic acid alkyl ester plasticizers such as tridodecyl tricarbalate, tributyl-meso-butane 1,2,3,4,-tetracarboxylate and the like, alkyl polycarboxylic acid cycloalkyl ester plasticizers such as tricyclohexyl tricarbalate, tricyclopopyl-2-hydroxy 1, 2, 3-propane tricarboxylate, alkyl polycarboxylic acid aryl ester plasticizers such as triphenyl 2-hydroxyl-1,2,3 propane tricarboxylate, tetra 3-methyl phenyl tetrahydrofuran 2, 3, 4, 5 tetracarboxylate and the like, cycloalkyl polycarboxylic acid alkyl ester plasticizers such as tetrahexyl-1, 2, 3, 4-cyclobutane tetracarboxylate, tetrabutyl 1,2,3,4,-dicyclopentane tetracarboxylate and the like, cycloalkyl polycarboxylic acid cycloalkyl ester plasticizers such as tetracyclopropyl-1,2,3,4-cyclobutane tetracarboxylate, tricyclohexyl 1,3,5-cyclohexyl tricarboxylate and the like, cycloalkyl polycarboxylic acid aryl ester plasticizers such as triphenyl-1,3,5-cyclohexyl tricarboxylate, hexa 4-methyl phenyl-1,2,3,4,5,6-cyclohexyl hexacarboxylate and the like, aryl polyhdric carboxylic acid alkyl ester plasticizers such as tridodecyl benzene-1,2,4-tricarboxylate, tetraoctyl benzene-1,2,4,5 tetracarboxylate and the like, aryl polyhdric carboxylic acid cycloalkyl ester plasticizers such as tricyclopentyl benzene-1,3,5-tricarboxylate, tetracyclohexyl benzene-1,2,3,5 tetracarboxylate and the like, and aryl polyhdric carboxylic acid aryl ester plasticizers such as triphenyl benzene-1,3,5-tetracarboxylate, hexa 4-methylphenyl benzene-1,2, 3,4,5,6-hexacarboxylate and the like. These alkoxy groups and cycloalkoxy groups may be the same or different, and may also be substituted and the substitution groups may be further substituted. The alkyl groups and the cycloalkyl groups may be mixed, and the substituent groups may be bonded to each other by common bonds. Furthermore, the aromatic ring of the phthalic acid may be substituted and may be a polymer such as a dimer, trimer, tetramer and the like. The phthalic acid ester part of the structure may be a part of the polymer or may be systematically included as a pendant. It may also be introduced into a part of the molecular structure of the additive such as the antioxidant, the acid scavenger the ultraviolet light absorber and the like.

Of the ester plasticizers formed from a polycarboxylic acid and a monoalcohol, dialkyl carboxylic acid alkyl esters are preferable, specifically the foregoing dioctyl adipate and tridecyl carboxylate.

(Other Plasticizers)

Other plasticizers that can be used in the present invention include phosphoric acid ester plasticizers, polymer plasticizers and the like.

Specific examples of the phosphoric acid ester plasticizer include phosphoric acid alkyl esters such as triacetyl phosphate, tributyl phosphate and the like, phosphoric acid cycloalkyl esters such as tricyclopentyl phosphate, cyclohexyl phosphate and the like, phosphoric acid aryl esters such as triphenyl phosphate, tricresyl phosphate, cresylphenyl phosphate, octyldiphenyl phosphate, diphenylbiphenyl phosphate, trioctyl phosphate, tributyl phosphate, trinaphtyl phosphate, triglyceryl phosphate, tris ortho-biphenyl phosphate. The substituent groups for these maybe the same or different, and may be further substituted. The substituent groups may be a mix of alkyl groups, cycloalkyl groups and aryl groups, and the substituent groups may be bonded to each other by common bonds.

Examples of the phosphoric acid ester also include alkylene bis (dialkyl phosphates) such as ethylene bis (dimethyl phosphate), butylene bis (diethyl phosphate) and the like, alkylene bis (diaryl phosphates such as ethylene bis (diphenyl phosphate), propylene bis (dinaphtyl phosphate) and the like, arylene bis (dialkyl phosphates) such as phenylene bis (dibutyl phosphate), biphenylene bis (dioctyl phosphate) and the like, arylene bis (diaryl phosphates) such as phenylene bis (diphenyl phosphate), naphtylene bis (ditriyl phosphate) and the like. These substituent groups may the same or different, and may be further substituted. The substituent groups may be a mix of an alkyl group, cycloalkyl groups and aryl groups, and the substituent groups may be bonded to each other by common bonds.

Furthermore, a part of the structure of the phosphoric acid ester may be a part of the polymer or may be systematically included as a pendant. It may also be introduced into a part of the molecular structure of the additive such as the antioxidant, the acid scavenger, the ultraviolet light absorber and the like. Of the compounds listed above, aryl ester phosphates and arylene bis (diaryl phosphates) are preferable, and more specifically, triphenyl phosphate and phenylene bis (diphenyl phosphate) are preferable.

Specific examples of the polymer plasticizer include acrylic polymers such as an aliphatic hydrocarbon polymer, an alicyclic hydrocarbon polymer, polyacrylate ether, methyl polymethacrylate and the like, vinyl polymers such as polyvinyl isobutyl ether, poly N-vinyl pyrrolidone and the like, styrene polymers such as polystyrene, poly 4-hydroxy styrene and the like, polyesters such as polybutylene succinate, polyethylene terephthalate, polyethylene naphthalate and the like, polyethers such as polyethylene oxide, polypropylene oxide and the like, polyamides, polyurethanes, polyurea and the like. The number average molecular weight is preferably about 1,000-500,000 and 5,000-20,000 is particularly preferable. If the number average molecular weight is less than 1,000 there are problems with respect to volatility, while if it exceeds 500,000 the plasticizing properties decrease and the mechanical properties of the cellulose ester derivative composition are adversely affected. The polymer plasticizer may be a homopolymer formed by repeating the same kind of polymer units, or may be a copolymer having a structure in which there is a plurality of repeated units. In addition, 2 or more of the polymers may be used together.

The amount of other plasticizer incorporated in cellulose ester is normally 0.1 to 50 weight parts, preferably 1 to 30 weight parts, and more preferably 3 to 15 weight parts in 100 weight parts of cellulose ester.

Together with to the compound having bothe a phenol moiety and a hindered amine moiety in the molecule of the present invention, the present invention, the following antioxidant or stabilizer may be added in the cellulose ester.

(Hindered Phenol Antioxidants)

By blending the hindered phenol antioxidant into the cellulose ester film, coloration or reduction in strength of the mold due to heat and deterioration caused by oxidation at the time of molding are prevented without reducing transparency and resistance to heat. Hindered phenol antioxidants may be used as the antioxidant in the present invention. The hindered phenol antioxidant is a structure having a large branched alkyl group at the ortho position of the hydroxide group of the phenol compound.

Examples of the antioxidant include known hindered phenol antioxidant compounds such as 2-6-dialkyl phenol derivatives and the like which are described in columns 12-14 of the specification of U.S. Pat. No. 4,839,405. These compounds include those represented by the Formula (1) below.

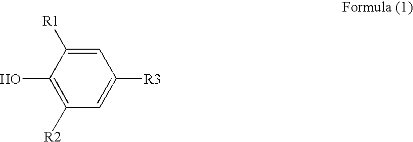

In the formula, R1, R2 and R3 represent an alkyl group substituent which may or may not be further substituted. Specific examples of the hindered phenol compound include n-octadyl 3-(3,5-di-t-butyl-4-hydroxyphenyl)-propionate, n-octadyl 3-(3,5-di-t-butyl-4-hydroxyphenyl)-acetate, n-octadecyl 3,5-di-t-butyl-4-hydroxybenzoate, n-hexyl 3,5-di-t-butyl-4-hydroxyphenylbenzoate, n-dodecyl 3,5-di-t-butyl-4-hydroxyphenylbenzoate, neo-dodecyl 3-(3,5-di-t-butyl-4-hydroxyphenyl)propionate, dodecyl β(3,5-di-t-butyl-4-hydroxyphenyl) propionate, ethyl α-(4-hydroxy 3,5-di-t-butylphenyl) isobutyrate, octadecyl α-(4-hydroxy 3,5-di-t-butylphenyl) isobutyrate, octadecyl α-(4-hydroxy 3,5-di-t-butyl-4-hydroxyphenyl) propionate, 2-(n-octylthio) ethyl 3,5-di-t-butyl-4-hydroxy-benzoate, 2-(n-octyl thio) ethyl 3, 5-di-t-butyl-4-hydroxy-phenyl acetate, 2-(n-octadecyl thio) ethyl 3,5-di-t-butyl-4-hydroxy-phenyl-acetate, 2-(n-octadecyl thio)ethyl 3,5-di-t-butyl-4-hydroxy-benzoate, 2-(2-hydroxy ethyl thio) ethyl 3,5-di-t-butyl-4-hydroxy-benzoate, diethyl glycol bis (3,5-di-t-butyl-4-hydroxy-phenyl) propionate, 2-(n-octadecyl thio) ethyl 3-(3,5-di-t-butyl-4-hydroxy-phenyl) propionate, stearamide N,N-bis-[ethylene 3-(3,5-di-t-butyl-4-hydroxy-phenyl) propionate], n-butyl imino N,N-bis-[ethylene 3-(3,5-di-t-butyl-4-hydroxy-phenyl) propionate], 2-(2 stearoyloxyethylthio) ethyl 3,5-di-t-butyl-4-hydroxy benzoate, 2-(2-stearoyloxyethylthio) ethyl 7-(3-methyl-5-t-butyl-4-hydroxy-phenyl) heptanoate, 1,2-propylene glycol bis-[3-(3,5-di-t-butyl-4-hydroxy-phenyl) propionate], ethylene glycol bis-[3-(3,5-di-t-butyl-4-hydroxy-phenyl) propionate], neopentyl glycol bis-[3-(3,5-di-t-butyl-4-hydroxy-phenyl) propionate], ethylene glycol bis-(3,5-di-t-butyl-4-hydroxy-phenyl acetate), glycerine-1-n-octadecanoate-2,3-bis-(3,5-di-t-butyl-4-hydroxyphenyl acetate), pentaerythritol-tetrakis[3-(3′,5′-di-t-butyl-4′-hydroxy-phenyl) propionate], 1,1,1-trimethyrol ethane tris [3-(3,5-di-t-butyl-4-hydroxy-phenyl) propionate], sorbitol hexa-[3-(3,5-di-t-butyl-4-hydroxy-phenyl) propionate], 2-hydroxyyethyl 7-(3-methyl-5-t-butyl-4-hydroxy-phenyl) propionate, 2-stearoyloxyethyl 7-(3-methyl-5-t-butyl-4-hydroxy-phenyl) heptanoate, 1,6-n-hexane diole bis[(3′,5′-di-t-butyl-4-hydroxy-phenyl) propionate], pentaerythritol-tetrakis (3,5-di-t-butyl-4-hydroxy hydroxinamate). The hindered phenol based antioxidant compounds of the type listed above are commercially available as “Irganox 1076” and “Irganox 1010” manufactured by Ciba Specialty Chemicals.

(Antioxidant)

Since decomposition of cellulose ester is accelerated by not only heat but oxygen under a high temperature environment such as in a melt casting process, it is preferable to incorporate an antioxidant as a stabilizer in optical film of the present invention.

In the present invention, cellulose ester having been suspension washed with a poor solvent is preferably utilized. At that time, a poor solvent containing an antioxidant is specifically preferably utilized. The utilized antioxidant will inactivate radicals generated in cellulose ester. Further, any compound, which can restrain deterioration of cellulose ester due to oxygen addition to the generated radicals, can be employed without limitation.

An antioxidant utilized in suspension washing of cellulose ester may remain in cellulose ester after washing. The remaining amount is preferably 0.01-2,000 ppm, more preferably 0.05-1,000 ppm and furthermore preferably 0.1-100 ppm.

As a useful antioxidant in the present invention, a compound, which restrains deterioration of a fusion molding material due to oxygen, can be utilized without limitation, and a more useful compound among them includes such as a phenol type compound, a hindered amine type compound, a phosphor type compound, a sulfur type compound, a heat resistant processing stabilizer and an oxygen scavenger. Specifically preferable among them are a phenol type compound, a hindered amine type compound and a phosphor type compound. By blending these compounds, it is possible to prevent coloring and strength decrease of a molded member, due to such as heat and thermal oxidation deterioration at the time of fusion molding, without deterioration of such as transparency and heat resistance. These antioxidants each can be utilized alone or in combination of at least two types.

A phenol type compound is a compound well known in the art and is described, for example, in columns 12-14 of U.S. Pat. No. 4,839,405 including 2,6-dialkylphenol derivative compounds. Among these compounds, examples of a preferable compound include those represented by Formula (A). 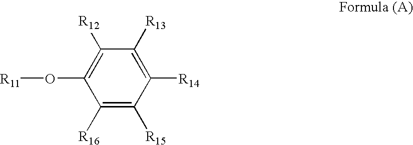
In Formula (A), R11, R12, R13, R14 and R15 each represent a substituent. Examples of the substituent include: a hydrogen atom, a halogen atom (for example, a fluorine atom and a chlorine atom), an alkyl group (for example, a methyl group, an ethyl group, an isopropyl group, a hydroxyethyl group, a methoxy methyl group, a trifluoro methyl group and a t-butyl group), a cycloalkyl group (for example, a cyclopentyl group and a cyclohexyl group), an aralkyl group (for example, a benzyl group and a 2-phenethyl group), an aryl group (for example, a phenyl group, a naphthyl group, p-tolyl group and a p-chlorophenyl group), an alkoxy group (for example, a methoxy group, an ethoxy group, an isopropoxy group and a butoxy group), an aryloxy groups (for example, a phenoxy group), a cyano group, an acylamino group (for example, an acetylamino group and a propionylamino group), an alkylthio group (for example, a methylthio group, an ethylthio group and a butylthio group), an arylthio group (for example, a phenylthio group), a sulfonylamino group (for example, a methanesulfonylamino group and a benzene sulfonyl amino group), an ureido group (for example, a 3-methylureido group, a 3,3-dimethylureido group and a 1,3-dimethylureido group), a sulfamoylamino group (for example, a dimethylsulfamoyl amino group), a carbamoyl group (for example, a methylcarbamoyl group, an ethylcarbamoyl group and a dimethylcarbamoyl group), a sulfamoyl group (for example, an ethylsulfamoyl group and a dimethylsulfamoyl group), an alkoxycarbonyl group (for example, a methoxycarbonyl group and an ethoxycarbonyl group), an aryloxycarbonyl group, (for example, a phenoxycarbonyl group), a sulfonyl group (for example, a methanesulfonyl group, a butane sulfonyl group and a phenylsulfonyl group), an acyl group (for example, an acetyl group, a propanoyl group and a butyroyl group), an amino group (for example, a methylamino group, an ethylamino group and a dimethylamino group), a cyano group, a hydroxy group, a nitro group, a nitroso group, an amineoxide group (for example, a pyridine oxide group), an imide group (for example, a phthalimide group), disulfide group (for example, a benzene disulfide group and a benzothiazolyl-2-disulfide group), a carboxyl group, a sulfo group and a heterocycle group (for example, a pyrrole group, a pyrrolidyl group, a pyrazolyl group, an imidazolyl group, a pyridyl group, a benzimidazolyl group, a benzthiazolyl group and a benzoxazolyl group). These substituents may be further substituted. Further, R11 is preferably a hydrogen atom, and R12 and R16 each are preferably a t-butyl group which is a phenolic compound. Examples of the phenol compound include: n-octadecyl-3-(3,5-di-t-butyl-4-hydroxyphenyl)propionate, n-octadecyl-3-(3,5-di-t-butyl-4-hydroxyphenyl)acetate, n-octadecyl-3,5-di-t-butyl-4-hydroxybenzoate, n-hexyl-3,5-di-t-butyl-4-hydroxyphenylbenzoate, n-dodecyl-3,5-di-t-butyl-4hydroxyphenylbenzoate, neo-dodecyl-3-(3,5-di-t-butyl-4-hydroxyphenyl)propionate, dodecyl-β-(3,5-di-t-butyl-4-hydroxyphenyl)propionate, ethyl-α-(4-hydroxy-3,5-di-t-butylphenyl)isobutyrate, octadecyl-α-(4-hydroxy-3,5-di-t-butylphenyl)isobutyrate, octadecyl-α-(4-hydroxy-3,5-di-t-butyl-4-hydroxyphenyl)propionate, 2-(n-octylthio)ethyl-3,5-di-t-butyl-4-hydroxy-benzoate, 2-(n-octylthio)ethyl-3,5-di-t-butyl-4-hydroxyphenylacetate, 2-(n-octadecylthio)ethyl-3,5-di-t-butyl-4-hydroxyphenylacetate, 2-(n-octadecylthio)ethyl-3,5-di-t-butyl-4-hydroxybenzoate, 2-(2-hydroxyethylthio)-ethyl-3,5-di-t-butyl-4-hydroxybenzoate, diethylglycol-bis-(3,5-di-t-butyl-4-hydroxyphenyl)propionate, 2-(n-octadecylthio)ethyl-3,5-di-t-butyl-4-hydroxyphenyl)-propionate, stearamide-N,N-bis-[ethylene-3-(3,5-di-t-butyl-4-hydroxyphenyl)propionate], N-butylimino-N,N-bis-[ethylene-3-(3,5-di-t-butyl-4-hydroxyphenyl)propionate], 2-(2-stearoyloxyethylthio)ethyl-3,5-di-t-butyl-4-hydroxybenzoate, 2-(2-stearoyloxyethylthio)ethyl-7-(3-methyl-5-t-butyl-4-hydroxyphenyl)heptanoate, 1,2-propyleneglycol-bis-[3-(3,5-di-t-butyl-4-hydroxyphenyl)propionate], ethyleneglycol-bis-[3-(3,5-di-t-butyl-4-hydroxyphenyl)propionate], neopentylglycol-bis-[3-(3,5-di-t-butyl-4-hydroxyphenyl)propionate], ethyleneglycol-bis-(3,5-di-t-butyl-4-hydroxyphenylacetate), glycerol-1-n-octadecanoate-2,3-bis-(3,5-di-t-butyl-4-hydroxyphenylacetate), pentaerythritoltetrakis[3-(3′,5′-di-t-butyl-4′-hydroxyphenyl)propionate], 1,1,1-trimethylolethane-tris-[3-(3,5-di-t-butyl-4-hydroxyphenyl) propionate], sorbitol-hexa-[3-(3,5-di-t-butyl-4-hydroxyphenyl)propionate], 2-hydroxyethyl-7-(3-methyl-5-t-butyl-4-hydroxyphenyl)propionate, 2-stearoyloxyethyl-7-(3-methyl-5-t-butyl-4-hydroxyphenyl)heptanoate, 1,6-n-hexanediol-bis-[(˜3′,5′-di-butyl-4-hydroxyphenyl)propionate] and pentaerythritoltetrakis(3,5-di-t-butyl-4-hydroxyhydrocinnamate). Above phenolic compounds have been commercialized, for example, as “Irganox1076” and “Irganox1010” from Ciba Specialty Chemicals, Inc.

As a hindered amine compound, preferable is a compound represented by Formula (B).

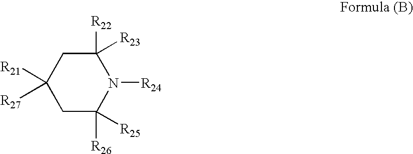

In Formula (B), R21, R22, R23, R24, R25, R26, and R27 each represent a substituent. Examples of the substituent are common to the substituents described for Formula (A). R24 is preferably a hydrogen atom or a methyl group, R27 is preferably a hydrogen atom and R22, R23, R25 and R26 each are preferably a methyl group.

Examples of a hindered amine compound include: bis(2,2,6,6-tetramethyl-4-piperidyl)sebacate, bis(2,2,6,6-tetramethyl-4-piperidyl)succinate, bis(1,2,2,6,6-pentamethyl-4-piperidyl)sebacate, bis(N-octoxy-2,2,6,6-tetramethyl-4-piperidyl)sebacate, bis(N-benzyloxy2,2,6,6-tetramethyl-4-piperidyl)sebacate, bis(N-cyclohexyloxy-2,2,6,6-tetramethyl-4-piperidyl)sebacate, bis(1,2,2,6,6-pentamethyl-4-piperidyl)-2-(3,5-di-t-butyl-4-hydroxybenzyl)-2-butylmalonate, bis(1-acroyl-2,2,6,6-tetramethyl-4-piperidyl)-2,2-bis(3,5-di-t-butyl-4-hydroxybenzyl)-2-butylmalonate, bis(1,2,2,6,6-pentamethyl-4-piperidyl)decanedioate, 2,2,6,6-tetramethyl-4-piperidylmethacrylate, 4-[3-(3,5-di-t-butyl-4-hydroxyphenyl) propionyloxy]-1-[2-(3-(3,5-di-t-butyl-4-hydroxyphenyl) propionyloxy)ethyl]-2,2,6,6-tetramethylpiperidine, 2-methyl-2-(2,2,6,6-tetramethyl-4-piperidyl)amino-N-(2,2,6,6-tetramethyl-4-piperidyl)propioneamide, tetrakis(2,2,6,6-tetramethyl-4-piperidyl)-1,2,3,4-butanetetracarboxylate and tetrakis(1,2,2,6,6-pentamethyl-4-piperidyl)-1,2,3,4-butanetetracarboxylate. Also, a polymer compound is preferable, examples of which include: N,N′,N″,N′″-tetrakis [4,6-bis-[butyl(N-methyl-2,2,6,6-tetramethylpiperidine-4-yl) amino]-triazine-2-yl]-4,7-diazadecane-1,10-diamine; a polycondensation compound of dibutylamine, 1,3,5-triazine N,N′-bis(2,2,6,6-tetramethyl-4-piperidyl)-1,6-hexamethylenediamine and N-(2,2,6,6-tetramethyl-4-piperidyl) butylamine; a polycondensation compound of dibutylamine, 1,3,5-triazine and N,N′-bis(2,2,6,6-tetramethyl-4-piperidyl) butylamine; poly[{(1,1,3,3-tetramethylbutyl)amino-1,3,5-triazine-2,4-diyl}{(2,2,6,6-tetramethyl-4-piperidyl)imino}hexamethylene{(2,2,6,6-tetramethyl-4-piperidyl)imino}]; a polycondensation compound of 1,6-hexanediamine-N,N′-bis(2,2,6,6-tetramethyl-4-piperidyl) and morpholine-2,4,6-trichloro-1,3,5-triazine; a high molecular weight HALS in which plurality of piperidine rings are combined via a triazine moiety, such as poly[(6-morpholino-s-triazine-2,4-diyl)[(2,2,6,6-tetramethyl-4-piperidyl)imino]-hexamethylene [(2,2,6,6-tetramethyl-4-piperidyl)imino]]; a polymer of dimethyl succinate and ˜4-hydroxy-2,2,6,6-tetramethyl-1-piperidineethanol; and a compound in which a piperizine ring is combined via a ester bond, such as a mixed ester compound of 1,2,3,4-butanetetracarboxylic acid, 1,2,2,6,6-pentamethyl-4-piperizinol and 3,9-bis(2-hydroxy-1,1-dimethylethyl)-2,4,8,10-tetraoxaspiro[5,5]undecane, however, the present invention is not limited thereto. Among these compounds, preferable are, for example, a polycondensation compound of dibutylamine, 1,3,5-triazine and N,N′-bis(2,2,6,6-tetramethyl-4-piperidyl)butylamine; poly[{(1,1,3,3-tetramethylbutyl)amino-1,3,5-triazine-2,4-diyl}{(2,2,6,6-tetramethyl-4-piperidyl)imino}hexamethylene{(2,2,6,6-tetramethyl-4-piperidyl)imino}]; and a polymer of dimethyl succinate and 4-hydroxy-2,2,6,6-tetramethyl-1-, which have a number average molecular weight (Mn) of 2,000-5,000. Above hindered-phenol compounds have been commercialized, for example, as “Tinuvin144” and “Tinuvin7700” from Ciba Specialty Chemicals, Inc.; and as “ADK STAB LA-52” from Asahi Denka Co., Ltd. Some of the compounds of the present invention are also included in the above examples, which means that the compound of the present invention are also usable as an antioxidant.

Examples of a preferable phosphor-containing compound include compounds represented by Formulas (C-1), (C-2), (C-3), (C-4), and (C-5). 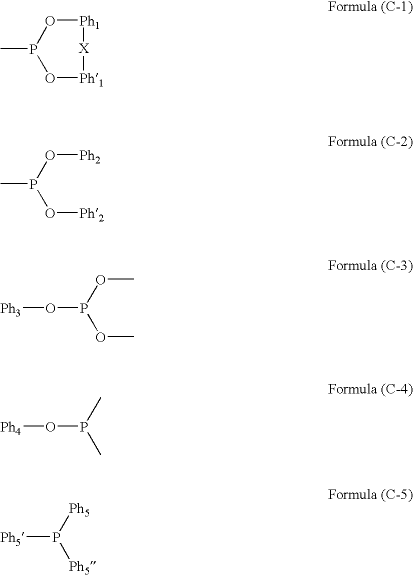
In the above Formulas (C-1), (C-2), (C-3), (C-4), and (C-5), Ph1 and Ph′1 each represent a substituent. Examples of the substituent are common to the substituents described for Formula (A). More preferably, Ph1 and Ph′1 each represent a phenylene group, and the hydrogen atom of the phenylene group may be replaced with a phenyl group, an alkyl group having 1 to 8 carbon atoms, a cycloalkyl group having 5 to 8 carbon atoms, an alkylcycloalkyl group having 6 to 12 carbon atoms, or an aralkyl group having 7 to 12 carbon atoms. Ph1 and Ph′1 may be mutually the same, or may be different. X represents a single bond, a sulfur atom, or a —CHR6-group. R6 represents a hydrogen atom, an alkyl group having 1 to 8 carbon atoms, or a cycloalkyl group having 5 to 8 carbon atoms. Further, these groups may be replaced with one of the substituents which are common to the substituents described for Formula (A). Ph2 and Ph′2 each represent one of the substituents which are common to the substituents described for Formula (A). More preferably, Ph2 and Ph′2 each represent a phenyl group or a biphenyl group. The hydrogen atom of the phenyl group or the biphenyl group may be replaced with an alkyl group having 1 to 8 carbon atoms, a cycloalkyl group having 5 to 8 carbon atoms, an alkylcycloalkyl group having 6 to 12 carbon atoms, or an aralkyl group having 7 to 12 carbon atoms. Ph2 and Ph′2 may be mutually the same or may be different, and Ph2 and Ph′2 may further be substituted with one of the substituents which are common to the substituents described for Formula (A). Ph3 represents one of the substituents which are common to the substituents described for Formula (A). More preferably, Ph3 represents a phenyl group or a biphenyl group. The hydrogen atom of the phenyl group or the biphenyl group may be replaced with an alkyl group having 1 to 8 carbon atoms, a cycloalkyl group having 5 to 8 carbon atoms, an alkylcycloalkyl group having 6 to 12 carbon atoms, or an aralkyl group having 7 to 12 carbon atoms. Ph3 may further be substituted with one of the substituents which are common to the substituents described for Formula (A). Ph4 represents one of the substituents which are common to the substituents described for Formula (A). More preferably, Ph4 represents an alkyl group having 1 to 20 carbon atoms or a phenyl group. The hydrogen atom of the alkyl group or the phenyl group may be replaced with one of the substituents which are common to those described for Formula (A). Ph5, Ph′5, and Ph″ 5 each represent one of the substituents which are common to the substituents described for Formula (A). More preferably, Ph2 and Ph′2 each represent an alkyl group having 1 to 20 carbon atoms or a phenyl group. The hydrogen atom of the alkyl group or the phenyl group may be replaced with one of the substituents which are common to the substituents described for Formula (A).

Examples of a phosphor-containing compound include: triphenyl phosphate; diphenylisodecyl phosphate; phenyldiisodecyl phosphate; tris(nonylphenyl) phosphate; tris(dinonylphenyl) phosphate; tris(2,4-di-t-butylphenyl) phosphite, 10-(3,5-di-t-butyl-4-hydroxybenzyl)-9,10-dihydro-9-oxa-10-phosphaphenanthrene-10-oxide; 6-[3-(3-t-butyl-4-hydroxy-5-methylphenyl)propoxy]-2,4,8,10-tetra-t-butyldibenz[d,f][1.3.2]dioxaphosphepin; a mono-phosphite compound such as tridecyl phosphate; diphosphite compounds such as 4,4′-butylidene-bis(3-methyl-6-t-butylphenyl-di-tridecyl phosphite) and 4,4′-isopropylidene-bis(phenyl-di-alkyl (C12-C15) phosphite); phosphonite compounds such as triphenyl phosphonite, tetrakis(2,4-di-tert-butylphenyl)[1,1-biphenyl]-4,4′-diylbisphosphonite and tetrakis(2,4-di-tert-butyl-5-methylphenyl)[1,1-biphenyl]-4,4′-diylbisphosphonite; phosphinite compounds such as triphenyl phosphinite and 2,6-dimethylphenyldiphenyl phosphinite; and phosphine compounds such as triphenyl phosphine and tris(2,6-dimethoxyphenyl) phosphine. Examples of above-mentioned commercially available phosphor-containing compounds include: “SumilizerGP” from Sumitomo Chemical Co., Ltd.; “ADK STAB PEP-24”, “ADK STAB PEP-36” and “ADK STAB 3010” from Asahi Denka Co., Ltd.; and “IRGAFOS P-EPQ” Ciba Specialty Chemicals, Inc.

As a sulfur-containing, preferable are the compounds represented by Formula (D).
R₃₁—S—R₃₂ Formula (D)

In Formula (D), R31 and R32 each represent one of the substituents which are common to the substituents described for Formula (A). Each of R31 and R32 is preferably an alkyl group. Examples of a sulfur-containing compound include: dilauryl-3,3-thio-dipropionate, dimyristyl-3,3′-thiodipropionate, distearyl-3,3-thio-dipropionate, laurylstearyl-3,3-thio-dipropionate, pentaerythritol-tetrakis (β-lauryl-thio-propionate), 3,9-bis(2-dodecylthioethyl)-2,4,8,10-tetra-oxaspiro[5,5]undecane. The above sulfur-containing compounds have been commercialized, for example, as “Sumilezer TPL-R” and “Sumilezer TP-D” from Sumitomo Chemical Co., Ltd.

As for an antioxidant, preferably removed is the impurity including a residual acid, inorganic salt or organic low molecular weight compound which may be incorporated in the production process or while being stored, as well as the cellulose ester as described above. The purity of an antioxidant is preferably 99% or more, and the contents of residual acid and impurity water are preferably 0.01 to 100 ppm, whereby, in the melt casting process of the cellulose ester, heat deterioration can be reduced, and also film-production stability, the optical property and the physical property of the film are improved.

Examples of other antioxidant include: 2-tert-butyl-6-(3-tert-butyl-2-hydroxy-5-methylbenzyl)-4-methyl phenyl acrylate, 2-[1-(2-hydroxy-3,5-di-tert-pentyl phenyl) ethyl]-4,6-di-tert pentyl phenyl acrylate and the like, compounds having a pyridine skeleton as part of the structure such as 3,4-di hydro-2H-1-benzopyrane based compounds, 3, 3′ spirocycloman based compounds, 1,1 spiroindan based compounds, morpholine, thiomorpholine, thiomorpholine oxide, thiomorpholine dioxide, which are described in JP-A 8-27508, and acid scavengers such as dialkoxybenzene based compounds and the like which are described in JP-A 3-174150. The antioxidant part of the structure may be a part of the polymer or may be systematically included as a pendant. It may also be introduced into a part of the molecular structure of the additive such as the plasticizer, the acid scavenger, the ultraviolet light absorber.

(Hindered Amine Light Stabilizer)

The hindered amine light stabilizers are structures having a large organic group (such as a large branched alkyl group) in the vicinity of the N atom. These are known compounds and examples include 2,2,6,6-tetraalkyl piperidine compounds and the acid addition salts or the metal salt complexes thereof which are described in columns 5-11 of the specification of U.S. Pat. No. 4,619,956 and columns 3-5 of the specification of U.S. Pat. No. 4,839,405. Examples of these compounds include those represented by the Formula (2) below.

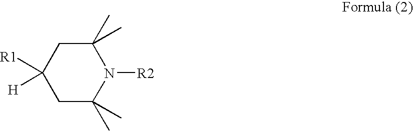

In the formula, R1 and R2 represent H or a substituent group. Specific examples of the hindered amine light stabilizers include 4-hydroxy-2,2, 6,6-tetramethyl piperidine, 1-aryl-4-hydroxy 2,2, 6,6-tetramethyl piperidine, 1-benzyl-4-hydroxy 2,2, 6,6-tetramethyl piperidine, 1-(4-t-butyl-2-butenyl)-4-hydroxy 2,2, 6,6-tetramethyl piperidine, 4-stearoyl oxy 2,2, 6,6-tetramethyl piperidine, 1-ethyl-4-saliscyloyoxy, 2,2, 6,6-tetramethyl piperidine, 4-metacryloyloxy-1,2,2,6,6-pentamethyl piperidine, 1,2,2,6,6-pentamethyl piperidine-4-yl-β (3,5 di-t-butyl-4-hydroxyphenyl)-propionate, 1-benzyl-2,2,6,6-tetramethyl-4-piperidinyl maleinate, (di 2,2,6,6-tetramethyl piperidine-4-yl)-adipate, (di 2,2,6,6-tetramethyl piperidine-4-yl) sepacate, (di 1,2,3,6-tetramethyl-2,6-diethyl-piperidine-4-yl)-sepacate, (di-1-aryl-2,2,6,6-tetramethyl-piperidine-4-yl) phthalate, 1-acetyl-2,2,6,6-tetramethyl-piperidine-4-yl acetate, trimellitic acid-tri-(2,2,6,6-tetramethyl-piperidine -4-yl) ester, 1-acryloyl-4-benzyloxy-2,2,6,6-tetramethyl-piperidine, dibutyl-malonic acid-di-(1,2,2,6,6-pentamethyl-piperidine-4-yl)-ester, dibenzyl-malonic acid di-(1,2,3,6-tetramethyl-2-6-diethyl piperidine-4-yl)-ester, dimethyl-bis-2,2,6,6-tetramethyl-piperidine-4-oxy)-silane, tris-(1-propyl-2,2,6,6-tetramethyl-piperidine-4-yl) phosphite, tris-(1-propyl-2,2,6,6-tetramethyl-piperidine-4-yl) phosphate, N—N′-bis-2,2,6,6-tetramethyl-piperidine-4-yl) -hexamethylene-1,6-diamine, tetrakis(2,2,6,6-tetramethyl-4-piperidyl)1,2,3,4-butanetetracarboxylate, tetrakis(1.2.2.6.6-pentamethyl-4-piperidyl)1,2,3,4-butanetetracarboxylate, N—N′-bis-2,2,6,6-tetramethyl-piperidine-4-yl)-hexamethylene-1,6-diacetamide, 1-acetyl-4-(N-cyclohexyl acetoamide)-2,2,6,6-tetramethyl-piperidine, 4-hexylamino-2,2,6,6-tetramethyl-piperidine, N—N′-bis-2,2,6,6-tetramethyl-piperidine-4-yl)-N—N′-dibutyl adipamide, N—N′-bis-(2,2,6,6-tetramethyl-piperidine-4-yl)-N—N′-dicyclohexyl-(2-hydroxypropylene), N—N′-bis-(2,2,6,6-tetramethyl-piperidine-4-yl)-p-xylelene-diamine, 4-(bis-2-hydroxyethyl)-amino-1,2,2,6,6-pentamethyl piperidine, 4-methacrylamide 1,2,2,6,6-pentamethyl piperidine, α-cyano-β-methyl-β-[N-(2,2,6,6-tetramethyl-piperidine -4-yl)]-amino-methyl ester acrylate.

Examples of the preferable hindered amine light stabilizers include those represented by HALS-1 and HALS-2 below.

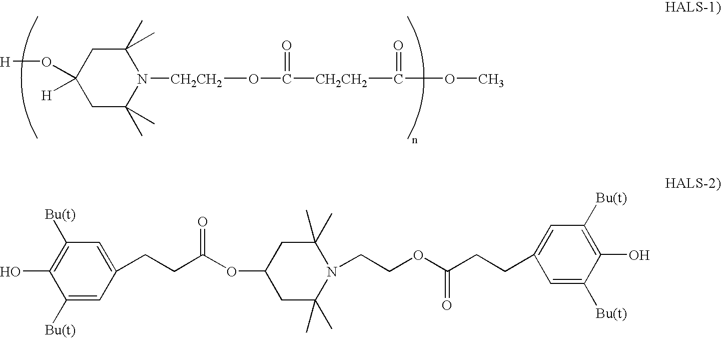

These hindered amine light stabilizers may be used singly or in combinations of 2 or more, and they may also be used with additives such as plasticizers, acid scavengers, ultraviolet light absorbers, or introduced into a part of the molecular structure of the additive.

(Acid Scavengers)

The acid scavenger is an agent that has the role of trapping the acid (proton acid) remaining in the cellulose ester that is brought in. Also when the cellulose ester is melted, the side chain hydrolysis is promoted due water in the polymer and the heat, and in the case of CAP, acetic acid or propionic acid is formed. It is sufficient that the acid scavenger is able to chemically bond with acid, and examples include but are not limited to compounds including epoxy, tertiary amines, and ether structures.

Specific examples include an epoxy compounds which are acid trapping agents described in the specification of U.S. Pat. No. 4,137,201. The epoxy compounds which are trapping agents include those known in the technological field, and examples include polyglycols derived by condensation such as diglyceril ethers of various polygycols, especially those having approximately 8-40 moles of ethylene oxide per mole of polyglycol, diglyceril ethers of glycerol and the like, metal epoxy compounds (such as those used in the past in vinyl chloride polymer compositions and those used together with vinyl chloride polymer compositions), epoxy ether condensation products, a diglycidyl ether of Bisphenol A (namely 2,2-bis(4-glycidyloxyphenyl)propane), epoxy unsaturated fatty acid esters (particularly alkyl esters having about 4-2 carbon atoms of fatty acids having 2-22 carbon atoms (such as butyl epoxy stearate) and the like, and various epoxy long-chain fatty acid triglycerides and the like (such as epoxy plant oils which are typically compositions of epoxy soy bean oil and the like and other unsaturated natural oils (these are sometimes called epoxyified natural glycerides or unsaturated fatty acids and these fatty acids generally have 12 to 22 carbon atoms)). Particularly preferable are commercially available epoxy resin compounds, which include an epoxy group such as EPON 815c, and other epoxyified ether oligomer condensates such as those represented by the Formula (3).

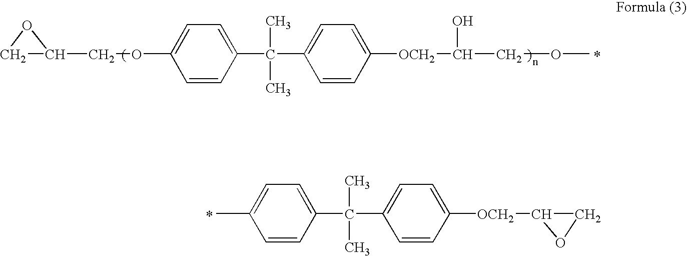

In the formula n is equal to 0-12. Other examples of acid trapping agents that can be used include those described in paragraphs 87-105 in JP-A 5-194788.

(Ultraviolet Light Absorbers)

The ultraviolet light absorber preferably has excellent ultraviolet light absorbance for wavelengths not greater than 370 nm in view of preventing deterioration of the polarizer or the display device due to ultraviolet light, and from the viewpoint of the liquid crystal display it is preferable that there is little absorbance of visible light which has wavelength of not less than 400 nm. Examples of the ultraviolet light absorbers include oxybenzophenone compounds, benzotriazole compounds, salicylic acid ester compounds, benzophenone compounds, cyano acrylate compounds nickel complex compounds and the like and benzophenone compounds as well as benzotriazole compounds which have little coloration are preferable. In addition, the ultraviolet light absorbers described in JP-A Nos. 10-182621 and 8-337574, and the high molecular weight ultraviolet light absorbers described in JP-A 6-148430 may also be used.

Specific examples of the benzotriazole based ultraviolet light absorbers include 2-(2′-hydroxy-5′ methylphenyl) benzotriazole, 2-(2′-hydroxy 3′,5′-di-tert-butyl phenyl) benzotriazole, 2-(2′-hydroxy 3′-tert-butyl-5′-methylphenyl) benzotriazole, 2-(2′-hydroxy 3′,5′-di-tert-butyl phenyl)-5-chlorobenzotriazole, 2-(2′-hydroxy 3′-(3″, 4″, 5″, 6″-tetrahydrophthalimide methyl)-5′-methylphenyl) benzotriazole, 2,2-methyl bis (4-(1,1,3,3,-tetramethyl butyl)-6-(2H-benzotriazole-2-yl) phenyl), 2-(2′-hydroxy-3′-tert-butyl-5′-methylphenyl)-5-chlorobenzotriazole, 2-(2H-benzotriazole-2-yl)-6-(straight chain or side chain dodecyl) -4-methylphenyl, and mixtures of octyl-3-[3-tert-butyl-4-hydroxy-5-(chloro-2H-benzotriazole-2-yl) phenyl]propionate and 2-ethylhexyl-3-[3-tert-butyl-4-hydroxy-5-(5-chloro-2H-benzotriazole-2-yl) phenyl]propionate. The benzotriazole based ultraviolet light absorber is however, not limited to these examples.

Commercially available TINUVIN 109, TINUVIN 171, and TINUVIN 360, which are manufactured by Chiba Specialty Chemical Co., Ltd. may also be used as the benzotriazole based ultraviolet light absorber.

Examples of the benzophenone based compound include 2,4-hydroxy benzophenone, 2,2′-dihydroxy-4-methoxy benzophenone, 2-hydroxy-4-methoxy-5-sulfobenzophenone, bis (2-methoxy-4-hydroxy-5-benzoyl phenyl methane) and the like, but are not limited thereto.

The amount of the ultraviolet light absorber used in the present invention is preferably 0.1-20 weight %, and more preferably 0.5-10 weight %, and still more preferably 1-5 weight %. Two or more of these may be used together.

(Matting Agent)

Fine particles such as a matting agent or the like may be added to the polarizing plate protective film of the present invention in order to impart a matting effect, and fine particles of inorganic compounds as well as fine particles of organic compounds may be used. The particles of the matting agent are preferably as fine as possible and examples of the fine particle matting agent include inorganic fine particles such as those of silicon dioxide, titanium dioxide, aluminum oxide, zirconium oxide, calcium carbonate, kaolin, talc, burned calcium silicate, hydrated calcium silicate, aluminum silicate, magnesium silicate, and calcium phosphate or cross-linked fine particles of high molecular weigh polymers of these, silicon dioxide is preferable in view of reduced haze in the film. The particles such as the silicon dioxide particles are often surface treated using an organic substance, and this is preferable because it reduces haze in the film.

Examples of the organic compound preferably used in the surface treatment include halogens, alkoxysilanes, silazanes, and siloxanes. Particles having a larger average particle diameter have a greater matting effect, while particles having a smaller average particle diameter have excellent transparency. The secondary particles should have an average primary particle diameter in the range of 0.05˜1.0 μm. The secondary particles preferably have an average primary particle diameter in the range of 5 to 50 nm, and more preferably 7 to 14 nm. These fine particles are preferable because they create unevenness of 0.01 to 1.0 μm in the plane of the cellulose ester film. The amount of the fine particles included in the cellulose ester is preferably 0.005-0.3 weight % of the cellulose ester.

Examples of the silicon dioxide particles include Aerosil 200, 200V, 300, R972, R972V, R974, R202, R812, OX50, or TT600 each manufactured by Nippon Aerosil Co., Ltd., and of these, Aerosil 200V, R972, R972V, R974, R202, and R812, are preferred. Two or more of these matting agents may be combined and used. In the case where 2 or more matting agents are used, they may be mixed in a suitably selected proportion. In this case, matting agents which have different particle diameter and quality such as Aerosil 200V and R972V may be used in weight proportions in the range from 0.1:99.9-99.9:0.1

The presence of the fine particles used as the matting agent in the film can also serve another purpose of improving the strength of the film. The presence of the fine particles in the film may also improve the orientation of the cellulose ester itself which composes the polarizing plate protective film of the present invention.

(Retardation Regulator)

In the polarizing plate protective film of the present invention, the orientation film is formed and the liquid crystal layer is provided thereon. The retardation originating from the polarizing plate protective film and the liquid crystal layer are combined and optical compensation capability is imparted, and polarizing plate processing is thereby performed such that the quality of the liquid crystal display is improved. The compounds added for regulating retardation include aromatic compounds having 2 or more aromatic rings which are described in the specification European Patent No. 911,656A2 which can be used as retardation regulators. Two or more of these compounds may be used together. The aromatic ring of these aromatic compounds may include aromatic heterocyclic rings in addition to aromatic hydrocarbon rings. The aromatic heterocyclic ring is preferable and the aromatic heterocyclic ring is generally an unsaturated heterocyclic ring. Of these, 1,3,5-triazine ring is particularly preferable.

(Other Additives)

Further, as other additives, a compound provided with both of a phenol structure and a phosphite ester structure in one molecule may be incorporated in cellulose ester film. Herein, a compound provided with both of a phenol structure and a phosphite ester structure in one molecule is preferably a compound represented by following Formula (4).

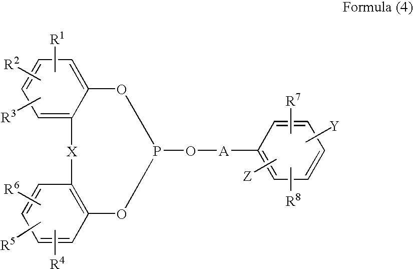

In phosphite esters represented by Formula (4) according to the present invention, substituents R1, R2, R4, R5, R7 and R8 each independently represent a hydrogen atom, an alkyl group having a carbon number of 1-8, a cycloalkyl group having a carbon number of 5-8, an alkylcycloalkyl group having a carbon number of 6-12, an aralkyl group having a carbon number of 7-12 or a phenyl group. R1, R2 and R4 are preferably an alkyl group having a carbon number of 1-8, a cycloalkyl group having a carbon number of 5-8 or an alkylcycloalkyl group having a carbon number of 6-12, and R⁵ is preferably a hydrogen atom, an alkyl group having a carbon number of 1-8 or a cycloalkyl group having a carbon number of 5-8.

Herein, typical examples of an alkyl group having a carbon number of 1-8 include such as methyl, ethyl, n-propyl, i-propyl, n-butyl, i-butyl, sec-butyl, t-butyl, t-pentyl, i-octyl, t-octyl and 2-ethylhexyl. Further, typical examples of a cycloalkyl group having a carbon number of 5-8 include such as cyclopentyl, cyclohexyl, cycloheptyl and cyclooctyl, and typical examples of an alkylcycloalkyl group having a carbon number of 6-12 include such as 1-methylcyclopentyl, 1-methylcyclohexyl and 1-methyl-4-1-propylcyclohexyl. Typical examples of an aralkyl group having a carbon number of 7-12 include such as benzyll α-methylbenzyl and α,α-dimethylbenzyl.

Among them, R1 and R4 are preferably a t-alkyl group such as t-butyl, t-pentyl and t-octyl; cyclohexyl or 1-methylcyclohexyl. R² is preferably an alkyl group having a carbon number of 1-5 such as methyl, ethyl, n-propyl, i-propyl; n-butyl, i-butyl, sec-butyl, t-butyl and t-pentyl; and specifically preferably metyl, t-butyl or t-pentyl. R⁵ is preferably a hydrogen atom or an alkyl group having a carbon number of 1-5 such as methyl, ethyl, n-propyl, i-propyl, n-butyl, i-butyl, sec-butyl, t-butyl and t-pentyl.

R3 and R6 each independently represent a hydrogen atom or an alkyl group having a carbon number of 1-8, and an alkyl group having a carbon number of 1-8 includes, for example, alkyl groups similar to those described before. Preferable is a hydrogen atom or an alkyl group having a carbon number of 1-5 and specifically preferable is a hydrogen atom or a methyl group.

Further, X represents a single bond, a sulfur atom or —CHR⁹— group (R9 represents an alkyl group having a carbon number of 1-8 or a cycloalkyl group having a carbon number of 5-8.). Herein, an alkyl group having a carbon number of 1-8 and a cycloalkyl group having a carbon number of 5-8 each include an alkyl groups and cycloalkyl groups similar to those described before. X preferably represents a single bond, a methylene group or a methylene group substituted by such as methyl, ethyl, n-propyl, i-propyl, n-butyl, i-butyl or t-butyl.

A represents an alkylene group having a carbon number of 2-8 or *—COR10- group (R10 represents a single bond or an alkylene group having a carbon number of 1-8, and * indicates to bond on the oxygen side.). Herein, typical examples of an alkylene group having a carbon number of 2-8 include such as ethylene, propylene, butylenes, pentamethylene, hexamethylene, octamethylene and 2,2-dimethyl-1,3-propylene, and propylene is preferably utilized. Further, * in *—COR¹⁰— indicates that carbonyl bonds to oxygen of phosphite. Typical examples of an alkylene group having a carbon number of 1-8 in R10 include such as methylene, ethylene, propylene, butylenes, pentamethylene, hexamethylene, octamethylene and 2,2-dimethyl-1,3-propylene. As R10, preferably utilized are such as a single bond and ethylene.

Either one of X or Y represents a hydroxyl group, an alkoxy group having a carbon number of 1-8 or an aralkyloxy group having a carbon number of 7-12, and the other represents a hydrogen atom or an alkyl group having a carbon number of 1-8. Herein, an alkyl group having a carbon number of 1-8 includes, for example, alkyl groups similar to those described before, and an alkoxy group having a carbon number of 1-8 includes, for example, alkoxy groups the alkyl portion of which is similar to alkyl groups having a carbon number of 1-8 described before. Further, an aralkyloxy group having a carbon number of 7-12 includes, for example, aralkyloxy group the aralkyl portion of which is similar to aralkyl groups having a carbon number of 7-12 described before.

The phosphite ester shown by above Formula (4) can be prepared, for example, by reacting a bisphenol compound represented by Formula (5), phosphorus trihalogenide and a hydroxy compound represented by Formula (6). 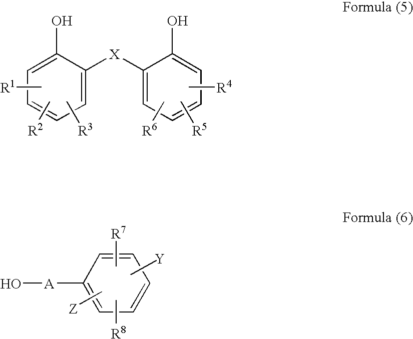
In Formulas (5) and (6), R1, R2, R3, X, R4, R5, R6, R7, R8, A, Y, and Z are common to those described for Formula (4). Examples of a bisphenol compound represented by Formula (5) include: 2,2′-methylene-bis(4-methyl-6-t-butylphenol), 2,2′-methylene-bis(4-ethyl-6-t-butylphenol), 2,2′-methylene-bis(4-n-propyl-6-t-butylphenol), 2,2′-methylene-bis(4-i-propyl-6-t-butylphenol), 2,2′-methylene-bis(4-n-butyl-6-t-butylphenol), 2,2′-methylene-bis(4-i-butyl-6-t-butylphenol), 2,2′-methylene-bis(4,6-di-t-butylphenol), 2,2′-methylene-bis(4-t-pentyl-6-t-butylphenol), 2,2′-methylene-bis(4-nonyl-6-t-butylphenol), 2,2′-methylene-bis(4-t-octyl-6-t-butylphenol), 2,2′-methylene-bis(4-methyl-6-t-pentylphenol), 2,2′-methylene-bis(4-methyl-6-cyclohexylphenol), 2,2′-methylene-bis[4-methyl-6-(α-methylcyclohexyl)phenol], 2,2′-methylene-bis(4-methyl-6-nonylphenol), 2,2′-methylene-bis(4-methyl-6-t-octylphenol), 2,2′-methylene-bis(4,6-di-t-pentylphenol), 2,2′-methylene-bis[4-nonyl-6-(α-methylbenzyl) phenol], 2,2′-methylene-bis[4-nonyl-6-(α,α-dimethylbenzyl)phenol], and 2,2′-ethylidene-bis (4-methyl-6-butylphenol). Examples of a hydroxy compound represented by Formula (6), when A is an alkylene having 2 to 8 carbon atoms, include: 2-(3-t-butyl-hydroxyphenyl)ethanol, 2-(3-t-pentyl-4-hydroxyphenyl)ethanol, 2-(3-t-octyl-4-hydroxyphenyl)ethanol, 2-(3-cyclohexyl-4-hydroxyphenyl)ethanol, 2-[3-(1-methylcyclohexyl)-4-Hydroxyphenyl]ethanol, 2-(3-t-butyl-4-hydroxy-5-methylphenyl)ethanol, 2-(3-t-pentyl-4-hydroxy-5-methylphenyl)ethanol, 2-(3-t-octyl-4-hydroxy-5-methylphenyl) ethanol, 2-(3-cyclohexyl-4-hydroxy-5-methylphenyl)ethanol, 2-[3-(1-methylcyclohexyl)-4-hydroxy-5-methylphenyl]ethanol, 2-(3-t-butyl-4-hydroxy-5-ethylphenyl)ethanol, 2-(3-t-pentyl-4-hydroxy-5-ethyl phenyl)ethanol, 2-(3-t-octyl-4-hydroxy-5-ethylphenyl)ethanol, 2-(3-cyclohexyl-4-hydroxy-5-ethylphenyl) ethanol and 2-[3-(1-methylcyclohexyl)-4-hydroxy-5-ethylphenyl]ethanol. Typical examples of a hydroxy compound represented by Formula (6), when A is a *—COR10- group, include: 3-t-butyl-2-hydroxybenzoic acid, 3-t-butyl-4-hydroxybenzoic acid, 5-t-butyl-2-hydroxybenzoic acid, 3-t-pentyl-4-hydroxybenzoic acid, 3-t-octyl-4-hydroxybenzoic acid, 3-cyclohexyl-4-hydroxybenzoic acid, 3-(1-methylcyclohexyl)-4-hydroxybenzoic acid, 3-t-butyl-2-hydroxy-5-methylbenzoic acid, 3-t-butyl-4-hydroxy-5-methylbenzoic acid, 5-t-butyl-2-hydroxy-3-methylbenzoic acid, 3-t-pentyl-4hydroxy-5-methylbenzoic acid, 3-t-octyl-4-hydroxy-5-methylbenzoic acid, 3-cyclohexyl-4-hydroxy-5-methylbenzoic acid, 3-(1-methylcyclohexyl)-4-hydroxy-5-methylbenzoic acid, 3-t-butyl-4-hydroxy-5-ethylbenzoic acid, 3-t-pentyl-4-hydroxy-5-ethylbenzoic acid, 3-t-octyl-4-hydroxy-5-ethylbenzoic acid and 3-cyclohexyl-4-hydroxy-5-ethylbenzoic acid.
Specific examples of a compound represented by such Formula (4) include:

### Compound 1: 6-[3-(3-tert-butyl-4-hydroxy-5-methylphenyl) propoxy]-2,4,8,10-tetrakis-tert-butyldibenzo[d,f][1.3.2]dioxaphodpepine; and

### Compound 2: 6-[3-(3,5-di-tert-butyl-4 hydroxyphenyl) propoxy]-2,4,8,10-tetrakis-tert-butyldibenzo[d,f][1.3.2]dioxaphodpepine

The weight content of a compound represented by Formula (4) for one kind of the compounds is normally 0.001-10.0 weight parts, preferably 0.01-5.0 weight parts, and more preferably 0.1-3.0 weight parts, in 100 weight parts of cellulose ester.

(Dimensional Stability)

It is preferable that the dimensional stability of the optical film of the present invention is such that the dimensional variation is less than ±1.0% at 80° C. and 90% RH with the reference being the dimensions of the film left for 24 hours at 23° C. and 55% RH. A variation of less than 0.5% is mor preferable while 0.1% is specifically preferable.

Regarding the optical film of the present invention, used as a protective film for a polarizing plate, if the variation in the optical film itself exceeds the above range of dimensional stability, the absolute value of the retardation and the orientation angle of the polarizing plate will differ from that of the initial setting, which will result in reduced capacity for improvement in display quality, or deterioration of display quality.

(Materials Composing the Film)

The presence of additives in the materials composing the film, such as the cellulose ester, plasticizer, antioxidant and others such as an ultraviolet light absorber, a matting agent and a retardation regulator which are added as appropriate, is favorable in view of preventing or controlling change in quality and deterioration of at least one of the materials comprising the film.

The amount of volatile components included when the materials composing the film are melted is not to be greater than 1 weight %, preferably not to be greater than 0.5 weight %, and more preferably not to be greater than 0.2 weight % and still more preferably not to be greater than 0.1 weight %. In the present invention, the differential thermal analysis-weight measurement from 30° C. to 350° C. is carried out by a commercially available differential thermal analysis-weight analyzer, TG/DTA 200 (manufactured by Seiko Instruments Inc.), and this amount is used as the amount of volatile components.

(Stretching Operation and Refractive Index Control)

The refractive index of the optical film of the present invention may be controlled by appropriate stretching. If the stretching is performed by a factor of 1.0-2.0 in one direction of the cellulose ester and by a factor of 1.01-2.5 perpendicular to the interior of the plane of the film, the refractive index can be controlled within a desirable range.

For example, stretching can be done sequentially or simultaneously in the longitudinal direction of the film and perpendicular to that, or in other words the width direction. If at this time, the stretching factor in at least one direction is too small, a sufficient phase difference is not obtained, while if it is too large, the stretching is difficult and breakage sometimes occurs.

For example, in the case of stretching in the direction of casting after melting, if contraction in the width direction is too large, the refractive index in the thickness direction becomes too large. In this case, correction can be done by controlling the contraction in the width direction or by stretching in the width direction. In the case of stretching in the width direction, distribution of the refractive index in the width sometimes occurs. This is sometimes seen when the tenter method is used, but a contraction force is generated in the middle portion of the film by stretching in the width direction. This phenomenon occurs because the ends are fixed and is called the bowing phenomenon. In this case also, the bowing phenomenon can be controlled by stretching in the direction of casting, and distribution of the width direction phase difference is reduced to thereby achieve correction.

Furthermore, by stretching the film in the biaxial directions that cross each other, variation in film thickness can be reduced. If the variation in the thickness of the polarizing plate protective film is too large, there is unevenness in the phase difference and this poses a problem in terms of unevenness in coloration when used in a liquid crystal display.

The variation in the thickness of the cellulose ester film support is preferably in the range of ±3%, and more preferably ±1%. A method of extrusion in the biaxial directions which cross each other is effective in order to achieve objects such as those above, and the stretching is performed such that the final stretch factor for the biaxial directions which cross each other is in the range of 1.0-2.0 for the casting direction, and 1.01-2.5 for the width direction, and preferably 1.01-1.5 for the casting direction, and 1.05-2.0 for the width direction.

In the case where a cellulose ester is used which obtains positive birefringence with respect to stress, a slow axis for the optical film can be provided in the width direction by stretching in the width direction. In this case, it is preferable that the slow axis of the optical film is in the width direction in order to improve the display quality in the present invention, and the stretching factor in the width direction must be greater than stretching factor in the casting direction.

The method for stretching the web is not particularly limited. Examples include, a method in which a plurality of rolls are caused to have differing peripheral speeds and stretching is done in the vertical direction by utilizing the difference in peripheral speed between the rolls; a method in which both ends of the web are fixed with clips or pins and the spaces between the pins or clips are extended in the forward direction to thereby carry out stretching in both the vertical and horizontal directions; a method in which widening in the width direction and stretching in the width direction are performed simultaneously; and a method in which widening in the vertical direction and stretching in the vertical direction are performed simultaneously. As a matter of course, these and other methods may be used in combination. In addition, in the case of the so-called tenter method, smooth stretching can be carried out by driving the clip portion using a linear driving method, and this method is favorable because it reduces the danger of breakage and the like.

Maintaining the width or stretching the width in the horizontal direction in the process of preparing the film is preferably performed by a tenter, and may be performed by a pin tenter or a clip tenter.

In the case where the optical film of the present invention is used as a polarizing plate protective film, the thickness of the protective film is preferably 10-500 μm. In particular a thickness no less than 20 μm is preferable and no less than 35 μm is more preferable. Also a thickness no greater than 150 μm is preferable and no greater than 120 μm is more preferable. Particularly favorable is a thickness between 25 and 90 μm. If the optical film is thicker than the above range, it will be too thick after polarizing plate processing, and the thickness will be unsuitable for the liquid crystal displays used in notebook type personal computers and mobile electronic devices which, in particular, need to be thin and lightweight. On the other hand, if the optical film is thinner than the above-described range, expression of retardation will be difficult, and the water vapor permeability of the film will be high while the ability of the film to protect itself against humidity will be reduced. Also, the thickness of the cellulose ester film preferably satisfies the above range.

The slow axis or the fast axis is present in the film plane and given that the angle formed in the direction of film formation is θ1, θ1 is preferably between −1° and +1°, and more preferably between −0.5° and +0.5°. θ1 can be defined as the orientation angle and can be measured using the automatic birefringence analyzer KOBRA-21ADH (manufactured by Oji Scientific Instruments).

If θ1 satisfies the above-described relationships, the displayed image will have a high luminance and this can contribute to the suppression or prevention of the escaping of light and thereby contribute to faithful color reproduction in the color liquid crystal display device.

(Polymer Material)

Polymer materials and oligomers other than cellulose ester may be suitably selected and mixed in the optical film of the present invention. The abovementioned polymer materials and oligomers preferably have excellent compatibility with cellulose ester and the transmissivity when formed as a film is preferably 80% or more, more preferably 90% or more and still more preferably 92% or more. The object of mixing at least one or more of polymer materials and oligomers other than cellulose ester is also to regulate viscosity during heat melting and to improve the physical properties of the film after film processing. In this case, additives other than those described above may be added.

(Film Preparation)

For example, the mixture of the cellulose ester and the additives of the present invention is subjected to hot air drying or vacuum drying and then subjected to melt extrusion, and then extruded as a film by a T-type die. The film is then placed in contact with a cooling drum using an electrostatic printing method and cold fixing is performed to obtain an unstretched film. The temperature of the cooling drum is preferably maintained at 90-150° C.

The melt extrusion may be performed using a uniaxial extruder, a biaxial extruder, or using a biaxial extruder which has a uniaxial extruder connected downstream thereof, but it is preferable that the uniaxial extruder is used in view of the mechanical strength and optical properties of the resulting film. Also, it is preferable that the usual ambient air supplied to the raw material tank, the raw material charge section and the extruder interior and during the melting process is replaced by an inactive gas such as nitrogen, or that the pressure of the ambient air is reduced.

The temperature during melt extrusion of the present invention is typically to be in the range of 150-300° C., more preferably 180-270° C., but still more preferably 200-250° C.

It is particularly preferable that in the case where a polarizing plate is prepared as the polarizing plate protective film for the optical film of the present invention, the cellulose ester film is formed by stretching in the width direction or in the longitudinal direction in regard to film formation.

The film is preferably peeled from the cooling drum and the resulting unstretched film is heated in the range from the glass transition temperature (Tg) of the cellulose ester to Tg+100° C. via a heating device, such as a plurality of heated rollers and/or infrared ray heaters, and stretched in a single or a plurality of steps. Next, the obtained cellulose ester film which is stretched in the longitudinal direction as described above, is preferably also stretched in the lateral direction in the range of Tg to Tg-20° C., after which the heat-fixing is conducted.

In the case of lateral stretching, if the stretching is done while sequentially heating the film at a stretch zone that is divided into more zones which have a temperature difference of 1-50° C., distribution of physical properties in the horizontal direction is reduced, which is favorable. Also, if after lateral stretching, the film is maintained for 0.01-5 minutes between the final lateral stretching temperature and Tg-40° C., the distribution of physical properties in the horizontal direction is further reduced which is also advantageous.

Heat-fixing is normally done within a range higher than the final lateral stretching temperature but not greater than Tg-20° C. for a period of 0.5-300 seconds. At that time, it is preferable that heat-fixing is done while sequentially increasing temperature in a stretch zone that is divided into two or more zones which have a temperature difference in the range of 1-100° C.

The film subjected to heat-fixing is usually cooled to a temperature less than the Tg, and the clip holding portion of both ends of the film is cut off and the film is wound up. At that time, it is preferable that a 0.1-10% relaxing process is performed in lateral and/or longitudinal direction at a range which is between the final heat-fixing temperature and the Tg. Also, cooling is preferably such that slow cooling from the final heat-fixing temperature to the Tg is achieved at a cooling rate not greater than 100° C. per second. The means for the slow cooling process is not particularly limited and can be performed by common known means, but it is particularly preferable to perform these processes while sequentially cooling in a plurality of temperature zones in view of improving the dimensional stability of the film. It is to be noted that, given that the final fixing temperature is T1 and the time for the film to reach Tg from the final heat-fixing temperature is “t”, the value for the cooling rate is determined by (T1−Tg)/t.

The optimal conditions for heat-fixing, cooling, and slow cooling processes differ depending on the cellulose ester comprising the film, and thus are determined by measuring the physical properties of the biaxially stretched film, and suitably adjusting the conditions to obtain favorable properties.

(Functional Layers)

When the optical film of the present invention is prepared, functional layers, for example, an antistatic layer, a hard coat layer, an anti-reflection layer, a matting layer, an adhesive layer, an anti-glare layer, a barrier layer and an optical compensation layer, may be provided prior to and/or after stretching. It is preferable that at least one layer selected from the anti-static layer, the hard coat layer, the anti-reflection layer, the adhesive layer, the antiglare layer and the optical compensation layer is provided. At that time, various surface treatments, for example, a corona discharge treatment, plasma treatment and chemical treatment may also be carried out, if necessary. In the present invention, a laminated cellulose ester film may be formed by co-extruding cellulose ester compositions containing different kinds of cellulose esters, different kinds of additives or different amounts of additives.

For example, a cellulose ester film can be made so as to have the structure of a skin layer/core layer/skin layer. A matting agent may be provided in a large amount in the skin layers or alternatively, may be only in the skin layer. A melt extruded layer of diacetyl cellulose which can be easily saponified may be formed as a skin layer. The melt extrusion of diacetyl cellulose can be carried out using a known method in the art. The plasticizer and the ultraviolet light absorber may be provided in a larger amount in the core layer than in the outermost layer, or may be only in the core layer. The types of plasticizers and ultraviolet light absorbers in the core layer and the skin may be changed and a low volatility plasticizer and/or an ultraviolet light absorber may be added to the skin layer, while a plasticizer with excellent plasticity or an ultraviolet light absorber with excellent ultraviolet light absorbing properties may be added to the core layer. The Tg of the skin layer and the core layer may be different, and it is preferably that the Tg of the core layer is lower than that of a skin layer. Further, the viscosity of the melt including the cellulose ester at the time of melt casting may differ in the skin layer and the core layer, and the viscosity of the skin layer may be greater than the viscosity of the core layer, or the viscosity of the core layer may be greater than or equal to the viscosity of a skin layer. A laminated film having uniform thickness may be obtained when the melt of a thinner layer (usally the skin layer) has a higher viscosity.

(Polarizing Plate)

When the cellulose ester film of the present invention is used as a protective film of a polarizing plate to be utilized in a liquid crystal display, it is preferable that the polarizing plate of the present invention is used on at least one surface of the liquid crystal cell, and more preferable is that the polarizing plates of the present invention are used on both surfaces of the liquid crystal cell.

As a conventional polarizing plate protective film, cellulose ester films of Konica Minolta TAC: KC8UX, KC4UX, KC5UX, KC8UY, KC4UY, KC8UCR-3, KC8UCR-4, KC12UR, KC8UXW-H, KC8UYW-HA, and KC8UX-RHA (produced by Konica Minolta Opto, Inc.), have been used.

The method to produce the polarizing plate of the present invention is not specifically limited and generally known methods are applicable. Obtained polarizing plate protective film of the present invention may be treated with an alkali solution and may be adhered on both surfaces of a polarizer film using an aqueous solution of fully saponified polyvinyl alcohol. The polarizer film can be prepared by immersing a polyvinyl alcohol film in an aqueous solution containing iodine, followed by stretching. This method is favorable because the polarizing plate protective film of the present invention can be directly adhered on at least one surface of a polarizer film.

Instead of the alkali treatment described above, an adhesive treatment, for example, disclosed in JP-A Nos. 6-94915 and 6-118232 may be carried out.

A polarizing plate contains a polarizer film and protective films which protect the both surfaces of the polarizer film. It is also possible to constitute a polarizing plate by adhering a protective film on one surface of the polarizing plate and a separate film on the reverse surface. The protective film and the separate film are employed to protect the polarizing plate at its shipping and product inspection. In this case, the protective film is adhered to protect the surface of the polarizing plate on the surface reverse to the surface which is adhered to a liquid crystal cell. On the other hand, the separate film is employed to cover the adhesion layer to adhere the polarizing plate to a liquid crystal cell.

(Liquid Crystal Display)

In a liquid crystal display, usually a substrate containing a liquid crystal cell is placed between two polarizing plates. Since the polarizing plate prepared by using the optical film of the present invention exhibits high dimensional stability, an excellent display performance is obtained even when the polarizing plate of the present invention is used in any portion of the liquid crystal display. On an outermost surface of the viewer side surface of a liquid crystal display, a polarizing plate protective film provided with, for example, a clear hard coat layer, an antistatic layer and an antireflection layer, is preferably employed. When a polarizing plate protective film is provided with an optical compensation layer or the film itself has a function of optical compensation, an excellent display performance is obtained by using the polarizing plate protective film in contact with the liquid crystal cell. The effect of the present invention is more markedly obtained by using the polarizing plate protective film of the present invention in a multi-domain mode liquid crystal display, more preferably in a multi-domain mode liquid crystal display of a birefringence mode.

The multi-domain mode refers to a method in which a pixel is divided into plural domains, and it is suitable for improving viewing angle dependency of images or symmetry of displayed images. On this mode, various methods have been reported, for example, in “Okita and Yamauchi, Liquid Crystal, 6(3), p303 (2002)”; and, on multi-domain mode liquid crystal display, for example, in “Yamada and Yamahara, LIQUID CRYSTAL, 7(2), p184 (2003)”, however, the present invention is not limited thereto.

The quality of the image is preferably symmetry when observed by a viewer. Accordingly, when the display is a liquid crystal display, multi-domaining of pixels is carried out in order to improve the symmetry on the viewing side of the display. The method for multi-domaining can be selected from those known in the art by considering the nature of liquid crystal mode, and, also, depending on binary or quaternary dividing of the pixel.

The present invention may be effectively employed in the liquid crystal displays of the following modes, for example: (i) a MVA (Multi-domain Vertical Alignment) mode which is one of typical examples of the vertical alignment mode, specifically a 4-domain MVA mode; (ii) a PVA (Patterned Vertical Alignment) mode which is multi-domained by patterned electrodes; and (iii)a CPA (Continuous Pinwheel Alignment) mode in which a Chiral force and patterned electrodes are merged. Use of an optically biaxial film in an OCB (Optically Compensated Bend) mode has been proposed in “T. Miyashita, T. Uchida, J. SID, 3(1), 29 (1995)” in which the polarizing plate of the present invention may be employed to exhibit the effect of the present invention. The order of stacking of polarizing plates and the type of liquid crystal mode is not limited, provided that the effect of the present invention is obtained by using the polarizing plate of the present invention.

Since the liquid crystal display exhibits high performance as an apparatus for displaying color images and moving pictures, the liquid crystal display, specifically a large-screen liquid crystal display, using the optical film of the present invention enables to provide faithful moving

### EXAMPLES

The present invention will now be further explained woth referring to the following examples, however, the present invention is not limited thereto. It is to be noted that “parts” hereinafter represents “parts by weight”.

### Example 1

[Preparation of Cellulose Ester Film]

Cellulose ester C-1 (CAP-482-20 manufactured by Eastman Chemical Co.) was dried in air for 2 hours at 130° C. and at ambient pressure, and then cooled to room temperature. 1.0 part by weight of compound 4 and 0.5 part by weight of Sumilizer BP-76 were added to 100 parts by weight of cellulose ester. The mixture was melted by heat to a melting temperature of 230° C. and then melt cast by extruding the melt from a T die. The resulting film was stretched at a stretching ratio of 1.2×1.2 at 160° C. to obtain a cellulose ester film having a thickness of 80 μm (Sample No. 1-1). The water content was determined by a heat-drying type MOISTURE ANALYZER MX-50 manufactured by A&D Co., Ltd.

Inventive samples Nos. 1-2 to 1-5 and 1-8 to 1-20 and comparative samples Nos. 1-6 and 1-7 were prepared in the same manner as Sample No. 1-1 except that the kind of cellulose ester, the water content, the kind of additive and the amount of additive were changed as shown in Table 1. The thickness of each cellulose ester film was 80 μm.

TABLE 1

| | | Water | | Amount | | Amount | |
|---|---|---|---|---|---|---|---|
| Sam- | Cel- | Content | | (parts | | (parts | |
| ple | lulose | (weight | | by | Com- | by | Re- |
| No. | Ester | %) | Plasticizer | weight) | pound | weight) | marks |
| 1-1 | C-1 | 1.0 | Chemical | 1 | 30 | 0.5 | Inv. |
| | | | 4 | | | | |
| 1-2 | C-1 | 1.0 | Chemical | 5 | 30 | 0.5 | Inv. |
| | | | 4 | | | | |
| 1-3 | C-1 | 1.0 | Chemical | 30 | 30 | 0.5 | Inv. |
| | | | 4 | | | | |
| 1-4 | C-1 | 1.0 | Chemical | 0.5 | 30 | 0.5 | Inv. |
| | | | 4 | | | | |
| 1-5 | C-1 | 1.0 | Chemical | 50 | 30 | 0.5 | Inv. |
| | | | 4 | | | | |
| 1-6 | C-1 | 1.0 | Chemical | 5 | Com- | 0.5 | Comp. |
| | | | 4 | | parative | | |
| | | | | | Com- | | |
| | | | | | pound 1 | | |
| 1-7 | C-1 | 1.0 | Com- | 5 | Com- | 0.5 | Comp. |
| | | | parative | | parative | | |
| | | | Com- | | Com- | | |
| | | | pound 2 | | pound 1 | | |
| 1-8 | C-1 | 1.0 | Chemical | 5 | 15 | 0.01 | Inv. |
| | | | 12 | | | | |
| 1-9 | C-1 | 1.0 | Chemical | 5 | 15 | 0.5 | Inv. |
| | | | 12 | | | | |
| 1-10 | C-1 | 1.0 | Chemical | 5 | 15 | 5 | Inv. |
| | | | 12 | | | | |
| 1-11 | C-1 | 1.0 | Chemical | 5 | 15 | 0.005 | Inv. |
| | | | 12 | | | | |
| 1-12 | C-1 | 1.0 | Chemical | 5 | 15 | 10 | Inv. |
| | | | 12 | | | | |
| 1-13 | C-1 | 1.0 | Chemical | 5 | 15 | 0.5 | Inv. |
| | | | 16 | | | | |
| 1-14 | C-1 | 3.0 | Chemical | 5 | 15 | 0.5 | Inv. |
| | | | 16 | | | | |
| 1-15 | C-1 | 5.0 | Chemical | 5 | 15 | 0.5 | Inv. |
| | | | 16 | | | | |
| 1-16 | C-1 | 1.0 | *1 | 8 | 19 | 0.25 | Inv. |
| 1-17 | C-1 | 1.0 | Dioctyl | 8 | 19 | 0.25 | Inv. |
| | | | sebacate | | | | |
| 1-18 | C-2 | 1.0 | Chemical | 8 | 7 | 0.5 | Inv. |
| | | | 12 | | | | |
| 1-19 | C-2 | 1.0 | Chemical | 8 | 34 | 0.5 | Inv. |
| | | | 16 | | | | |
| 1-20 | C-2 | 1.0 | Dioctyl | 8 | 40 | 0.5 | Inv. |
| | | | sebacate | | | | |

Inv.: Inventive sample,
Comp.: Comparative sample
*1: di-2-ethylhexyladipate
Chemical 4

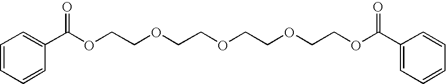

Chemical 12

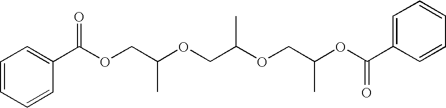

Chemical 16

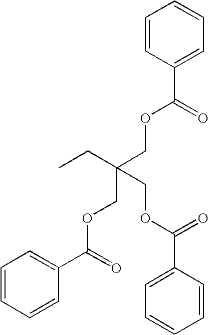

Di2-ethylhexyladipate

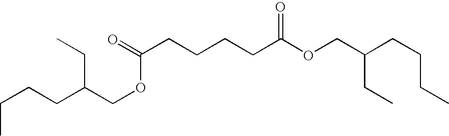

Dioctylsebacate

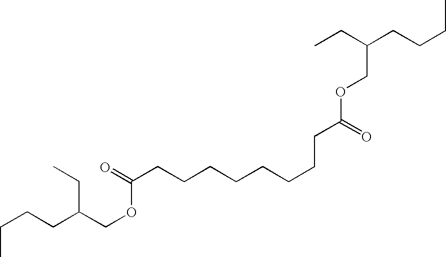

Comparative compound 1

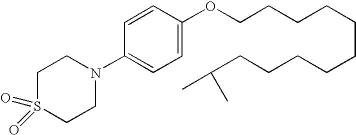

C-1: Cellulose Acetate Propionate CAP482-20 (manufactured by Eastman Chemical Co.)
C-2: Cellulose Acetate Butyrate CAB171-15 (manufactured by Eastman Chemical Co.)

Comparative compound 2: Pinecrystal KR-85
(hydrogenated rosin, (manufactured by Arakawa Chemical Industries, Ltd.)

Inventive samples Nos. 1-1 to 1-5 and 1-8 to 1-20, and Comparative samples Nos. 1-6 and 1-7, thus prepared, were evaluated as described below. The results were summarized in Table 2.

[Evaluation]

(Coefficient of Variation (CV) of Retardation Values)

Retardation values of thus obtained film were measured at points of every 1 cm in the lateral direction (width direction) of the film to calculate a coefficient of variation (CV) of the retardation values. The retardation values were defined by the following Equations. Three dimensional birefringent index was measurement using an automatic birefringence meter KOBRA-21ADH, manufactured by Oji Scientific Instruments, at a wavelength of 590 nm under an atmosphere of a temperature of 23° C. and a relative humidity of 55% RH. The CV value was calculated using the following equation.
Ro=(nx−ny)×d
Rt={(nx+ny)/2−nz}×d

In the above equations, nx is the maximum in-plane retardation value (also referred to as a refractive index in the slow axis direction), ny is an in-plane refractive index in the direction perpendicular to the slow axis direction, nz represents a refractive index in the thickness direction, and d is the thickness of the film in nm. The standard deviation for each of the in-plane retardation values and the retardation values in the thickness direction was calculated using a (n−1) method. The distribution of the retardation values was expressed using a coefficient of variation (CV) as an index. In the measurement, n in the (n−1) method was set in the range of 130 to 140.
Coefficient of variation (CV)=(Standard deviation)/(Average retardation value)

The criteria for the evaluation of CV values were as follows.

A: The CV value (variation) is less than 1.5%.

B: The CV value is 1.5% or more but less than 5%.

C: The CV value is 5% or more but less than 10%.

D: The CV value is 10% or more.

(Haze)

The results of measured haze using a haze meter (1001 DP model manufactured by Nippon Denshoku Industries Co., Ltd.) were converted to the haze values for the cellulose ester film having a thickness of 80 μm. The criteria for the evaluation were as follows:

A: The haze value was less than 0.1%

B: The haze value was 0.1% or more but less than 1.0%.

C: The haze value was 1.0% or more but less than 1.5%.

D: The haze value was 1.5% or more but less than 2.0%.

E: The haze value was 2.0% or more.

(Measurement of the Luminescent Foreign Materials)

Two polarizing plates were arranged in a crossed Nicol state to block light transmission, and each cellulose ester film sample was inserted between the two polarizing plates. Polarizing plates having a glass protective plate were used. Light was irradiated on one side of the sample and the number of luminescent points having a diameter of 0.01 mm or more per 1 cm² were counted from the opposite side using an optical microscope (magnification of 50). The criteria for the evaluation was as follows:

A: The number of luminescent points was 0 to 30.

B: The number of luminescent points was 31 to 50.

C: The number of luminescent points was 51 to 80.

D: The number of luminescent points was 81 to 100.

E: The number of luminescent points was 101 or more.

TABLE 2

| | Coefficient of | | Luminescent | |
|---|---|---|---|---|
| Sample | variation (CV) of | | Foreign | |
| No. | retardation | Haze | Materials | Remarks |
| 1-1 | B | B | B | Inv. |
| 1-2 | A | A | B | Inv. |
| 1-3 | B | B | B | Inv. |
| 1-4 | C | C | C | Inv. |
| 1-5 | C | B | C | Inv. |
| 1-6 | D | D | E | Comp. |
| 1-7 | D | E | D | Comp. |
| 1-8 | B | B | B | Inv. |
| 1-9 | A | B | A | Inv. |
| 1-10 | B | B | B | Inv. |
| 1-11 | C | C | B | Inv. |
| 1-12 | C | C | C | Inv. |
| 1-13 | A | A | A | Inv. |
| 1-14 | B | B | B | Inv. |
| 1-15 | C | C | C | Inv. |
| 1-16 | B | A | B | Inv. |
| 1-17 | B | A | B | Inv. |
| 1-18 | A | B | B | Inv. |
| 1-19 | B | A | A | Inv. |
| 1-20 | B | A | A | Inv. |

Inv.: Inventive sample,
Comp.: Comparative sample

As shown in Tables 1 and 2, Inventive samples Nos. 1-1 to 1-5 and 1-8 to 1-20 were found to exhibit superior optical properties, with respect to coefficient of variation of retardation, haze and luminescent foreign materials, when compared with those of Comparative samples samples Nos. 1-6 and 1-7.

[Preparation of Coating Composition]

(Antistatic Layer Coating Composition (1))

| | |
|---|---|
| Polymethyl metacrylate | 0.5 part |
| (weight average molecular weight: 550,000; Tg: 90° C.) | |
| Propylene glycol monomethyl ether | 60 parts |
| Methyl ethyl ketone | 16 parts |
| Ethyl lactate | 5 parts |
| Methanol | 8 parts |
| Conductive polymer resin P-1 (0.1-0.3 μm particle diameter) | 0.5 part |

Conductive polymer resin P-1

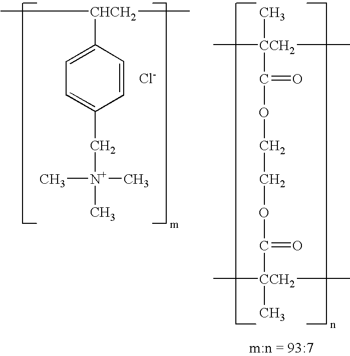

(Hard Coat Layer Coating Composition (2))

| | | |
|---|---|---|
| Dipentaerythritol hexaacrylate monomer | 60 | parts |
| Dipentaerythritol hexaacrylate dimer | 20 | parts |
| Dipentaerythritol hexaacrylate trimer and | 20 | parts |
| greater components | | |
| Diethoxybenzophenone photoreaction initiator | 6 | parts |
| Silicone surfacant | 1 | part |
| Propylene glycol monomethyl ether | 75 | parts |
| Methyl ethyl ketone | 75 | parts |
| (Anti-curl layer coating composition (3)) | | |
| Acetone | 35 | parts |
| Ethyl acetate | 45 | parts |
| Isopropyl alcohol | 5 | parts |
| Diacetyl cellulose | 0.5 | part |
| Superfine particles of silica 2% acetone dispersion | 0.1 | part |
| (Aerosil 200V manufactured by Nippon Aerosil Co., Ltd.) | | |

Polarizing plate protective films provided with additional function are prepared as described below.

[Polarizing Plate Protective Film]

On one surface of optical film No. 1-21, which was prepared in the same manner as sample 1-1 except that the stretching ratios were 1.2 in the longitudinal direction and 2.0 in the lateral direction, an anti-curl layer coating composition (3) was applied using gravure coating such that wet coat thickness was 13 μm, and then dried at a drying temperature of 80±5° C. The optical film sample 1-21A was thus obtained. Next, the other surface of the optical film was coated with an antistatic layer coating composition (1) at 28° C. and 82% RH at film conveyance speed of 30 m/min and a coating width of 1 m such the thickness of the wet film was 7 μm, and then dried at the drying section which was set at 80±5° C. to obtain a resin layer with a dry film thickness of about 0.2 μm. A cellulose ester film with an antistatic layer was thus obtained, which was designated as optical film sample No. 1-21B.

In addition, the hard coat layer coating composition (2) was coated on the antistatic layer such that the thickness of the wet film was 13 μm, and then dried at a drying temperature of 90° C., subsequently, ultraviolet rays were irradiated at 150 mJ/cm² and a clear hard coat layer having a dry thickness of 5 μm was obtained, which was designated as optical film sample 1-21C.

The obtained optical film sample 1-21A, sample 1-21B, and sample 1-21C had favorable coating properties without brushing or without any cracking after drying.

Optical film samples of the present invention Nos. 1-22A, B, C to 1-25A, B, C and 1-28A, B, C to 1-40A, B, C, were prepared in the same manner as Optical film samples Nos. 1-21A, B, C except that Cellulose ester film samples Nos. 1-2 to 1-5 and 1-8 to 1-20 were used in stead of Cellulose ester film sample No. 1-1, and favorable coating properties were confirmed in all these samples.

For comparison, the same coating method was performed using Cellulose ester film sample No. 1-26.

The sample on which the anti-curl layer coating composition (3) was applied was designated as sample No. 1-26A; the sample on which the antistatic layer coating composition (1) was also applied was designated as sample No. 1-26B; and the sample on which the hard coat layer coating composition (2) was further applied to the antistatic layer was designated as sample No. 1-26C.

The results reveal that when coating was carried out in a high humidity environment, brushing occurred in sample No. 1-26A. Also, in the sample No. 1-26B, fine cracks after drying were occasionally observed and in sample 1-26C fine cracks after drying were obviously observed.

Comparative optical film samples Nos. 1-27A, B, C were prepared in the same manner as Comparative optical film samples Nos. 1-26A, B, C except that Comparative cellulose film samples Nos. 1-27 was used.

[Preparation of Polarizing Plate]

A 120 μm thick polyvinyl alcohol film was immersed in an aqueous solution containing 1 part by weight of iodine, 2 parts by weight of potassium iodide and 4 parts by weight of boric acid, in 100 parts by weight of pure water, and stretched at 50° C. by a factor of 4 to obtain a polarizer film film.

Surfaces of Inventive samples Nos. 1-1 to 1-5 and 1-8 to 1-20, and Comparative samples Nos. 1-6 and 1-7 were subjected to alkali treatment at 40° C. for 60 seconds in 2.5 M aqueous solution of sodium hydroxide and then washed in water followed by drying.

The alkali treated surfaces of two films of each of Inventive samples Nos. 1-1 to 1-5 and 1-8 to 1-20, and Comparative samples Nos. 1-6 and 1-7 were adhered to both surfaces of a polarizer film obtained as above, using a 5% completely saponified polyvinyl alcohol aqueous solution as an adhesive. The inventive polarizing plates Nos. 1-1 to 1-5,1-8 to 1-14 and 1-16 to 1-20, and, comparative polarizing plates Nos. 1-6,1-7 and 1-15 having protective films were thus obtained.

The inventive polarizing plates Nos. 1-1 to 1-5 and 1-8 to 1-20, exhibited superior optical and physical properties and the degree of polarization was favorable, when compared with comparative polarizing plates Nos. 1-6 and 1-7.

[Evaluation of Properties as a Liquid Crystal Display]

The polarizing plate of a 15-inch TFT color liquid display LA-1529HM (manufactured by NEC Corporation) was peeled off and each of the polarizing plates prepared above were cut to fit the size of the liquid crystal cell. Two polarizing plates of each sample prepared above were adhered to the liquid cell so that the liquid crystal cell was interposed therebetween, wherein the polarizing axis of each polarizing plate was laid in the same direction as that of the original polarizing axis, while the two polarizing axes of each two polarizing plates orthogonally crossed with each other. The 15-inch TFT color liquid crystal displays were thus obtained and the properties as the polarizing plate of the cellulose ester films were evaluated. In the inventive polarizing plates Nos. 1-1 to 1-5 and 1-8 to 1-20, the contrast was higher and the display properties were superior when compared to comparative polarizing plates Nos. 1-6 and 1-7. This confirms that the inventive polarizing plates are superior as the polarizing plate for an image display device such as a liquid crystal display.

### Example 2

In the same manner as Example 1, cellulose ester films having the kind of cellulose ester, the water content, the kind of additive and the amount of additive as summarized in Table 3 were prepared. The results of evaluation carried out as above were summarized in Table 4. The chemical structures of Comparative compounds 3 and 4 are shown below.

TABLE 3
Comparative compound 3

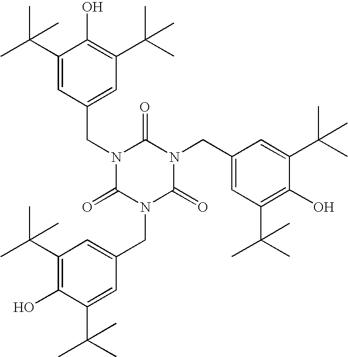

(IRGANOX 3114)
Comparative compound 4

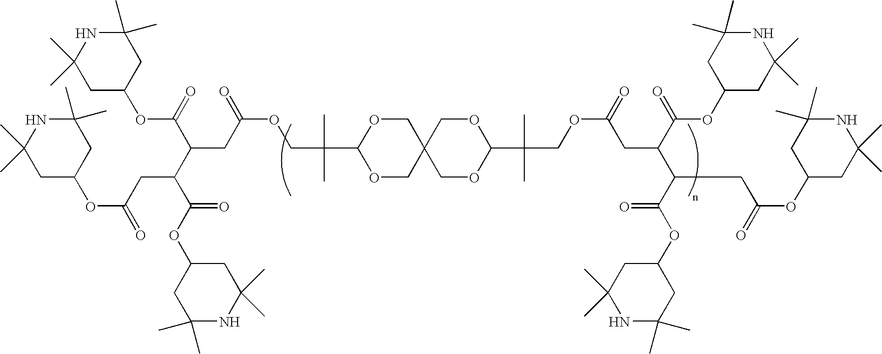

(ADK STAB LP-68LD)

| | Cellulose | Water Content | | Amount | | Amount | |
|---|---|---|---|---|---|---|---|
| Sample No. | Ester | (weight %) | Plasticizer | (parts by weight) | Compound | (parts by weight) | Remarks |
| 2-1 | C-1 | 1.0 | Chemical 4 | 1 | 10 | 0.5 | Inv. |
| 2-2 | C-1 | 1.0 | Chemical 4 | 5 | 10 | 0.5 | Inv. |
| 2-3 | C-1 | 1.0 | Chemical 4 | 30 | 10 | 0.5 | Inv. |
| 2-4 | C-1 | 1.0 | Chemical 4 | 0.5 | 10 | 0.5 | Inv. |
| 2-5 | C-1 | 1.0 | Chemical 4 | 50 | 10 | 0.5 | Inv. |
| 2-6 | C-1 | 1.0 | Chemical 4 | 5 | Comparative | 0.5 | Comp. |
| | | | | | Compound 1 | | |
| 2-7 | C-1 | 1.0 | Comparative | 5 | Comparative | 0.5 | Comp. |
| | | | Compound 2 | | Compound 1 | | |
| 2-8 | C-1 | 1.0 | Compound 4 | 5 | Comparative | 0.5/0.5 | Comp. |
| | | | | | Compounds 3/4 | | |
| 2-9 | C-1 | 1.0 | Chemical 12 | 5 | 23 | 0.01 | Inv. |
| 2-10 | C-1 | 1.0 | Chemical 12 | 5 | 23 | 0.5 | Inv. |
| 2-11 | C-1 | 1.0 | Chemical 12 | 5 | 23 | 5 | Inv. |
| 2-12 | C-1 | 1.0 | Chemical 12 | 5 | 23 | 0.005 | Inv. |
| 2-13 | C-1 | 1.0 | Chemical 12 | 5 | 23 | 10 | Inv. |
| 2-14 | C-1 | 1.0 | Chemical 16 | 5 | 6 | 0.5 | Inv. |
| 2-15 | C-1 | 3.0 | Chemical 16 | 5 | 6 | 0.5 | Inv. |
| 2-16 | C-1 | 5.0 | Chemical 16 | 5 | 6 | 0.5 | Inv. |
| 2-17 | C-1 | 1.0 | *1 | 8 | 27 | 0.25 | Inv. |
| 2-18 | C-1 | 1.0 | Dioctyl sebacate | 8 | 27 | 0.25 | Inv. |
| 2-19 | C-2 | 1.0 | Chemical 12 | 8 | 5 | 0.5 | Inv. |
| 2-20 | C-2 | 1.0 | Chemical 16 | 8 | 9 | 0.5 | Inv. |
| 2-21 | C-2 | 1.0 | *1 | 8 | 11 | 0.5 | Inv. |
| 2-22 | C-2 | 1.0 | Dioctyl sebacate | 8 | 28 | 0.5 | Inv. |
| 2-23 | C-2 | 1.0 | Dioctyl sebacate | 8 | 41 | 0.5 | Inv. |
| 2-24 | C-2 | 1.0 | Dioctyl sebacate | 8 | 46 | 0.5 | Inv. |
| 2-25 | C-2 | 1.0 | Dioctyl sebacate | 8 | 50 | 0.5 | Inv. |

Inv.: Inventive sample,
Comp.: Comparative sample
*1: di-2-ethylhexyladipate

TABLE 4

| | Coefficient of | | Luminescent | |
|---|---|---|---|---|
| Sample | variation (CV) of | | Foreign | |
| No. | retardation | Haze | Materials | Remarks |
| 2-1 | B | B | B | Inv. |
| 2-2 | A | A | B | Inv. |
| 2-3 | B | A | B | Inv. |
| 2-4 | C | C | C | Inv. |
| 2-5 | C | B | B | Inv. |
| 2-6 | D | E | E | Comp. |
| 2-7 | D | D | D | Comp. |
| 2-8 | D | E | D | Comp. |
| 2-9 | B | B | B | Inv. |
| 2-10 | A | B | A | Inv. |
| 2-11 | B | B | B | Inv. |
| 2-12 | C | B | C | Inv. |
| 2-13 | C | C | C | Inv. |
| 2-14 | A | A | B | Inv. |
| 2-15 | B | B | B | Inv. |
| 2-16 | A | C | C | Inv. |
| 2-17 | B | B | B | Inv. |
| 2-18 | B | A | B | Inv. |
| 2-19 | B | B | B | Inv. |
| 2-20 | B | A | A | Inv. |
| 2-21 | B | B | A | Inv. |
| 2-22 | B | B | B | Inv. |
| 2-23 | B | A | A | Inv. |
| 2-24 | B | B | A | Inv. |
| 2-25 | A | B | B | Inv. |

Inv.: Inventive sample,
Comp.: Comparative sample

As shown in Tables 3 and 4, Inventive samples Nos. 2-1 to 2-5 and 2-9 to 2-25, were found to exhibit superior optical properties, with respect to coefficient of variation of retardation, haze and luminescent foreign materials, when compared with those of Comparative samples Nos. 2-6 to 2-8.

The polarizing plate protective films, polarizing plates and liquid crystal displays were prepared using the above samples and the same results as Example 1 were obtained.

### Example 3

In the same manner as Example 1, cellulose ester films having the kind of cellulose ester, the water content, the kind of additive and the amount of additive as summarized in Table 5 were prepared. The results of evaluation carried out in the same manner as Example 1 were summarized in Table 6.

TABLE 5

| | | Water | | Amount | | Amount | |
|---|---|---|---|---|---|---|---|
| | | Content | | (parts | | (parts | |
| Sample | Cellulose | (weight | | by | | by | |
| No. | Ester | %) | Plasticizer | weight) | Compound | weight) | Remarks |
| 3-1 | C-1 | 1.0 | Chemical 4 | 5 | 1 | 0.1 | Inv. |
| 3-2 | C-2 | 1.0 | Chemical 12 | 5 | 1 | 0.1 | Inv. |
| 3-3 | C-3 | 1.0 | Chemical 16 | 5 | 1 | 0.1 | Inv. |
| 3-4 | C-4 | 1.0 | *1 | 8 | 1 | 0.1 | Inv. |
| 3-5 | C-4 | 1.0 | Dioctyl | 8 | 1 | 0.1 | Inv. |
| | | | sebacate | | | | |
| 3-6 | C-3 | 1.0 | Chemical 16 | 5 | 15 | 0.1 | Inv. |
| 3-7 | C-3 | 1.0 | Dioctyl | 8 | 19 | 0.1 | Inv. |
| | | | sebacate | | | | |

Inv.: Inventive sample,
Comp.: Comparative sample
*1: di-2-ethylhexyladipate

C-3: Cellulose acetate propionate (degree of acetyl substitution of 1.9, degree of propionyl substitution of 0.8, molecular weights: Mn=70,000, Mw=220,000, and Mw/Mn of 3)

C-4: Cellulose triacetate

TABLE 6

| | Coefficient of | | Luminescent | |
|---|---|---|---|---|
| Sample | variation (CV) of | | Foreign | |
| No. | retardation | Haze | Materials | Remarks |
| 3-1 | B | B | A | Inv. |
| 3-2 | A | B | B | Inv. |
| 3-3 | A | A | A | Inv. |
| 3-4 | B | B | A | Inv. |
| 3-5 | B | B | A | Inv. |
| 3-6 | B | A | A | Inv. |
| 3-7 | A | A | B | Inv. |

Inv.: Inventive sample

As shown in Tables 5 and 6, Inventive samples Nos. 3-1 to 3-7 were found to exhibit superior optical properties, with respect to coefficient of variation of retardation, haze and luminescent foreign materials.

The polarizing plate protective films, polarizing plates and liquid crystal displays were prepared using the above samples and the same results as Example 1 were obtained.

What is claimed is:

1. A method of producing a cellulose ester film comprising the steps of:
(i) melting a cellulose ester containing 5.0% by weight or less of water at a temperature in the range of 150 to 300° C.; and
(ii) melt casting the molten cellulose ester to form the cellulose ester film,
wherein a compound having both a phenol moiety and a hindered amine moiety in the molecule is incorporated in the cellulose ester.

2. The method of claim 1, wherein the compound having both a phenol moiety and a hindered amine moiety in the molecule comprises at least two hindered amine moieties in the molecule.

3. The method of claim 1, wherein the compound having both a phenol moiety and a hindered amine moiety in the molecule is a compound having the phenol moiety at an end of the molecule and the hindered amine moiety at another end of the molecule.

4. The method of claim 1, wherein the compound having both a phenol moiety and a hindered amine moiety in the molecule is a hydroxybenzylmalonic ester derivative represented by Formula (I) or an acid addition salt thereof: 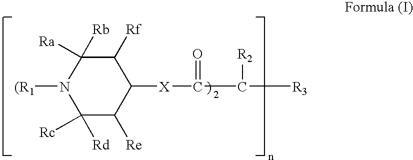
wherein, in Formula (I):
(a) n represents 1 or 2;
(b) Ra, Rb and Rd each represent an alkyl group having 1 to 6 carbon atoms;
(c) Rc represents an alkyl group having 1 to 9 carbon atoms;
(d) Re and Rf each represent a hydrogen atom or an alkyl group having 1 to 5 carbon atoms, provided that Re and Rf are exchangeable with each other;
(e) X represents a —O— group or a —NR— group (R represents a hydrogen atom or an alkyl group);
(f) R₁ represents a hydrogen atom, an —O. group, an alkyl group having 1 to 12 carbon atoms, an alkenyl group having 3 or 4 carbon atoms or an A-CO— group where A represents an alkyl group having 1 to 12 carbon atoms;
(g) R₂ represents a hydroxybenzyl group represented by Formula (II); and
(h) when n=1, R₃ represents one of the following groups:
(i) an alkyl group having 1 to 10 carbon atoms, the alkyl group being substituted with at least one of the following groups: an alkyl group having 1 to 20 carbon atoms, a —COOR₁₂ group (wherein R₁₂ represents an alkyl group having 1 to 18 carbon atoms or a group represented by Formula (III)), a —OCOR₁₃ group (wherein R₁₃ represents a phenyl group which may be substituted with an alkyl group having 1 to 4 carbon atoms or a hydroxyl group, or may have no substituent), and a —P(O) (OR₁₄)₂ group (wherein R₁₄ represents an alkyl group having 1 to 8 carbon atoms),
(ii) an alkenyl group having 3 to 18 carbon atoms,
(iii) an aralkyl group of 7 having 19 carbon atoms,
(iv) a phenyl group,
(v) a —OCOR₁₅ group (wherein R₁₅ represent a phenyl group substituted with two alkyl groups each having 1 to 4 carbon atoms and a hydroxyl group, or an alkyl group having 1 to 12 carbon atoms), and
(vi) a —NHCOR₁₆ group (wherein R₁₆ represents an alkyl group having 1 to 12 carbon atoms), and
when n=2, R₃ represents an alkylene group having 1 to 20 carbon atoms: 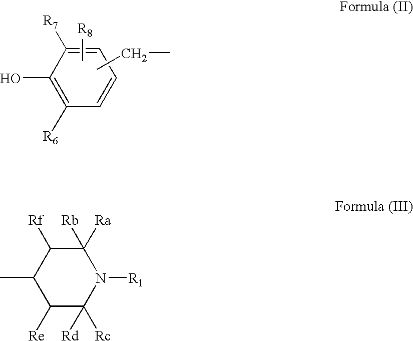
wherein, in Formula (II), R₆ and R₇ each independently represent an alkyl group having 1 to 9 carbon atoms and R₈ represents a hydrogen atom or a methyl group), and in Formula (III), R1, Ra, Rb, Rc, Rd, Re and Rf are common to R1, Ra, Rb, Rc, Rd, Re and Rf, respectively, in Formula (I).

5. The method of claim 4, wherein, in Formula (I), Ra, Rb, Rc and Rd each represent a methyl group, and Re and Rf each represent a hydrogen atom.

6. The method of claim 4, wherein, in Formula (I):
(a) X represents a —O— group or a —NH— group;
(b) R₁ represents a hydrogen atom, an —O. group, an alkyl group having 1 to 4 carbon atoms, an allyl group, or an acetyl group;
(c) R₂ represents a hydroxybenzyl group represented by Formula (IIa) or Formula (IIb);
(d) when n=1, R₃ represents one of the following groups:
(i) an alkyl group having 1 to 4 carbon atoms, the alkyl group being substituted with 1 or 2 groups of: a non-substituted alkyl group having 1 to 18 carbon atoms, a —COOR₁₂ group (wherein R₁₂ represents an alkyl group having 1 to 4 carbon atoms or a group represented by Formula (III)), an —OCOR₁₃ group (wherein R₁₃ represents a phenyl group), and a —P(O) (OR₁₄)₂ group (wherein R₁₄ represents an alkyl group having 1 to 4 carbon atoms),
(ii) an alkenyl group having 3 to 6 carbon atoms,
(iii) a phenyl group,
(iv) an aralkyl group of 7 having 15 carbon atoms,
(v) a —OCOR₁₅ group (wherein R₁₅ represent an alkyl group having 1 to 12 carbon atoms, a phenyl group, a 3,5-di-tertiarybutyl-4-hydroxyphenyl group or a 2-(3,5-di-tertiarybutyl)-4-hydroxyphenyl-ethyl group), and
(vi) a —NHCOR₁₆ group (wherein R₁₆ represents an alkyl group having 1 to 12 carbon atoms), and
when n=2, R₃ represents an alkylene group having 1 to 12 carbon atoms: 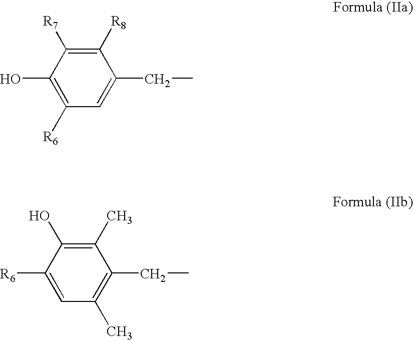
wherein, in Formulae (IIa) and (IIb), R₆ and R₇ each independently represent an alkyl group having 1 to 4 carbon atoms and R₈ represents an hydrogen atom or a methyl group.

7. The method of claim 4, wherein, in Formula (I):
(a) n represents 1 or 2;
(b) Ra, Rb, Rc and Rd each represent a methyl group;
(c) Re and Rf each represent a hydrogen atom;
(d) X represents an —O— group;
(e) R₁ represents a hydrogen atom, an —O. group, an alkyl group having 1 to 4 carbon atoms, an allyl group, or an acetyl group;
(f) R₂ represents a hydroxybenzyl group represented by Formula (IIa) or Formula (IIb); and
(g) R₃ represents one of the following groups:
(i) an alkyl group having 1 to 18 carbon atoms, the alkyl group being substituted with one or two groups of: a non-substituted alkyl group having 1 to 18 carbon atoms, and a —COOR₁₂ group (wherein R₁₂ represents an alkyl group having 1 to 4 carbon atoms or a group represented by Formula (IIIa)); or a —P(O)(OR₁₄)₂ group (wherein R₁₄ represents an alkyl group having 1 to 4 carbon atoms),
(ii) an ally group,
(iii) a benzyl group,
(iv) a phenyl group,
(v) an alkylene group having 1 to 8 carbon atoms, and
(vi) a xylylene group: 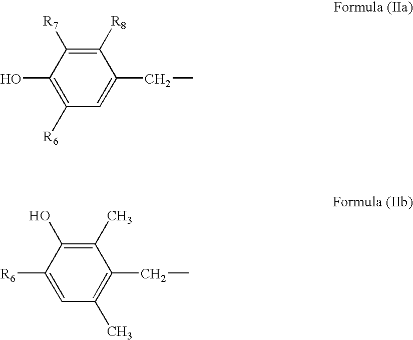
wherein, in Formulas (IIa) and (IIb), R₆ represents a tertiary butyl group, R₇ represents a methyl group or a tertiary butyl group and R₈ represents a hydrogen atom or a methyl group, 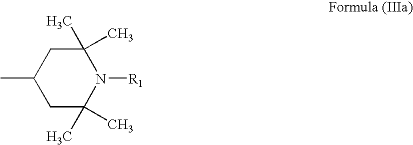
wherein, in Formula (IIIa), R₁ is common to R₁ in Formula (I).

8. The method of claim 4, wherein, in Formula (I):
(a) n represents 1 or 2;
(b) Ra, Rb and Rd each represent an alkyl group having 1 to 6 carbon atoms;
(c) Rc represents an alkyl group having 1 to 9 carbon atoms;
(d) Re and Rf each represent a hydrogen atom or an alkyl group having 1 to 5 carbon atoms, provided that Re and Rf are exchangeable with each other;
(f) R₁ represents a hydrogen atom, an —O. group, an alkyl group having 1 to 12 carbon atoms, an alkenyl group having 3 or 4 carbon atoms or an A-CO— group where A represents an alkyl group having 1 to 12 carbon atoms;
(g) R₂ represents a hydroxybenzyl group represented by Formula (II); and
(h) when n=1, R₃ represents one of the following groups:
(i) an alkyl group having 1 to 10 carbon atoms, the alkyl group being substituted with one of the following groups: a non-substituted alkyl group having 1 to 20 carbon atoms, a —COOR₁₂ group (wherein R₁₂ represents an alkyl group having 1 to 18 carbon atoms or a group represented by Formula (III)), a —OCOR₁₃ group (wherein R₁₃ represents a phenyl group which may be substituted with an alkyl group having 1 to 4 carbon atoms or a hydroxyl group, or may have no substituent), and a —P(O) (OR₁₄)₂ group (wherein R₁₄ represents an alkyl group having 1 to 8 carbon atoms),
(ii) an alkenyl group having 3 to 18 carbon atoms,
(iii) an aralkyl group of 7 having 19 carbon atoms, and
(iv) a phenyl group;
when n=2, R₃ represents an alkylene group having 1 to 20 carbon atoms.

9. The method of claim 1, wherein the cellulose ester comprised in the cellulose ester film is selected from the group consisting of: cellulose acetate, cellulose propionate, cellulose butyrate, cellulose acetate propionate, cellulose acetate butyrate, cellulose acetate phthalate and cellulose phthalate.

10. The method of claim 1, wherein the cellulose ester film comprises at least one of the following plasticizers: an ester plasticizer comprising a polyalcohol and a monocarboxylic acid; and an ester plasticizer comprising a polycarboxylic acid and a monoalcohol.

11. The method of claim 10, wherein the cellulose ester film comprises an alkylpolyalcohol aryl ester plasticizer or a dialkylcarboxylic acid alkyl ester plasticizer.

12. The method of claim 10, wherein a weight content of the ester plasticizer comprising a polyalcohol and a monocarboxylic acid or the ester plasticizer comprising a polycarboxylic acid and a monoalcohol, is in the range of 1 to 30% by weight based on the weight of the cellulose ester.

13. The method of claim 1, wherein a weight content of the compound having both a phenol moiety and a hindered amine moiety in the molecule is in the range of 0.01 to 5% by weight based on the weight of the cellulose ester.

14. The method of claim 1, wherein the cellulose ester contains 3.0% by weight or less of water.

15. A cellulose ester film produced by the method of claim 1.

16. An optical film employing the cellulose ester film of claim 15.

17. A polarizing plate produced by adhering the optical film of claim 16 on a surface of a polarizer film.

18. A liquid crystal display employing the optical film of claim 16 or a polarizing plate produced by adhering the optical film of claim 16 on a surface of a polarizer film.
